(19) United States
(12) Patent Application Publication
(10) Pub. No.: US 2025/0153188 A1
(43) Pub. Date: May 15, 2025

(54) AIR PURIFIER AND AIR PURIFYING APPARATUS COMPRISING SAME

(71) Applicant: Samsung Electronics Co., Ltd., Suwon-si (KR)

(72) Inventors: Juyoung KIM, Suwon-si (KR); Changhyun PARK, Suwon-si (KR); Nakhyun KIM, Suwon-si (KR); Huiyoung KIM, Suwon-si (KR); Juwan PARK, Suwon-si (KR); Changwoo JUNG, Suwon-si (KR); Seoyoung CHO, Suwon-si (KR); Sunghyun CHUN, Suwon-si (KR)

(21) Appl. No.: 19/020,219

(22) Filed: Jan. 14, 2025

Related U.S. Application Data
(63) Continuation of application No. PCT/KR2023/013083, filed on Sep. 1, 2023.

(30) Foreign Application Priority Data
Oct. 6, 2022 (KR) 10-2022-0128134
Nov. 17, 2022 (KR) 10-2022-0154702

(51) Int. Cl. B03C 3/12; B03C 3/011; B03C 3/36

(52) U.S. Cl. CPC B03C 3/12; B03C 3/011; B03C 3/368; B03C 2201/32

(57) ABSTRACT

An air purifier is provided. The air purifier includes a housing, an inner frame arranged inside the housing, a filter assembly configured to remove foreign substances from air introduced into the housing, and to be detachably mounted on the inner frame, and a detection module configured to detect whether the filter assembly is mounted, wherein the filter assembly includes a dust collection filter detachably mounted on the inner frame in a mounting direction (AX), and a pre-filter detachably mounted on the dust collection filter in a direction parallel to the mounting direction, and is arranged on a flow path that is toward the dust collection filter, and wherein the detection module includes a first sensor provided in the inner frame to detect whether the dust collection filter is mounted, and a second sensor provided in the inner frame to detect whether the pre-filter is mounted.

### CROSS-REFERENCE TO RELATED APPLICATION(S)

This application is a continuation application, claiming priority under § 365(c), of an International application No. PCT/KR2023/013083, filed on Sep. 1, 2023, which is based on and claims the benefit of a Korean patent application number 10-2022-0128134, filed on Oct. 6, 2022, in the Korean Intellectual Property Office, and of a Korean patent application number 10-2022-0154702, filed on Nov. 17, 2022, in the Korean Intellectual Property Office, the disclosure of each of which is incorporated by reference herein in its entirety.

### BACKGROUND

### 1. Field

The disclosure relates to an air purifier and an air purifying apparatus including the same.

### 2. Description of Related Art

Air purifying apparatuses are designed to improve indoor air quality in various indoor spaces, such as homes or offices, and examples of air purifying apparatuses may include air purifiers for removing foreign substances, such as fine dust, through a filter.

An air purifier may include an introduction port through which polluted indoor air is introduced, a filter for purifying the polluted indoor air, and a discharge port through which the purified air is discharged. The air purifier may be equipped with a fan to generate a flow of air.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an air purifier and an air purifying apparatus including the same.

Additional aspects will be set forth in part in the description which follows and, in part, will be apparent from the description, or may be learned by practice of the presented embodiments.

In accordance with an aspect of the disclosure, an air purifier is provided. The air purifier includes a housing, an inner frame arranged inside the housing, a filter assembly configured to remove foreign substances from air introduced into the housing, and to be detachably mounted on the inner frame, and a detection module configured to detect whether the filter assembly is mounted, wherein the filter assembly includes a dust collection filter detachably mounted on the inner frame in a mounting direction (AX), and a pre-filter detachably mounted on the dust collection filter in a direction parallel to the mounting direction, and is arranged on a flow path that is toward the dust collection filter, and wherein the detection module includes a first sensor provided in the inner frame to detect whether the dust collection filter is mounted, and a second sensor provided in the inner frame to detect whether the pre-filter is mounted.

In accordance with another aspect of the disclosure, an air purifying apparatus is provided. The air purifying apparatus includes the air purifier configured to remove dust from air, and an air sterilizer configured to sterilize the air from which the dust has been removed, wherein the air purifier includes a housing, an inner frame arranged inside the housing, a filter assembly configured to remove foreign substances from the air introduced into the housing, and to be detachably mounted on the inner frame and a detection module configured to detect whether the filter assembly is mounted, wherein the filter assembly includes a dust collection filter detachably mounted on the inner frame in a certain mounting direction, and a pre-filter that is detachably mounted on the dust collection filter in a direction parallel to the mounting direction, and is arranged on a flow path that leads to the dust collection filter, and wherein the detection module includes a first sensor provided in the inner frame to detect whether the dust collection filter is mounted, and a second sensor provided in the inner frame to detect whether the pre-filter is mounted.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view illustrating an air purifier according to an embodiment of the disclosure;

FIG. 2 is an exploded perspective view illustrating an air purifier according to an embodiment of the disclosure;

FIG. 3 is an exploded perspective view of a portion of an air purifier according to an embodiment of the disclosure;

FIG. 4 is a cross-sectional view of an air purifier according to an embodiment of the disclosure;

FIG. 5 is a perspective view illustrating a state in which a filter assembly is detached from an air purifier, according to an embodiment of the disclosure;

FIG. 6 is a cross-sectional perspective view illustrating a state in which a filter assembly is mounted on an inner frame of an air purifier, according to an embodiment of the disclosure;

FIG. 7 is an enlarged view of a portion of an air purifier of FIG. 6 according to an embodiment of the disclosure;

FIG. 8 is an exploded perspective view of a filter assembly according to an embodiment of the disclosure;

FIG. 9 is a perspective view illustrating an assembled filter assembly according to an embodiment of the disclosure;

FIGS. 10 and 11 are perspective views illustrating a pre-filter detached from a filter assembly of FIG. 9, seen from different angles, according to various embodiments of the disclosure;

FIG. 12 is a side view illustrating a state in which a pre-filter is mounted on a dust collection filter in a filter assembly, according to an embodiment of the disclosure;

FIGS. 13, 14, and 15 are diagrams illustrating a movement of a guide protrusion in a second guide unit when a pre-filter moves in a mounting direction according to various embodiments of the disclosure;

FIG. 16 is an exploded perspective view illustrating an air purifier according to an embodiment of the disclosure;

FIG. 17 is an exploded perspective view illustrating a state in which a filter assembly is detached from an inner frame in an air purifier, according to an embodiment of the disclosure;

FIG. 18 is an exploded perspective view illustrating a state in which a pre-filter is detached from a filter assembly, according to an embodiment of the disclosure;

FIG. 19 is a cross-sectional view illustrating a state in which a pre-filter is mounted in an air purifier, according to an embodiment of the disclosure;

FIG. 20 is a diagram illustrating a distance between a magnet and a second sensor in a state in which the pre-filter is mounted in the air purifier of FIG. 19 according to an embodiment of the disclosure;

FIG. 21 is a diagram illustrating a protruding portion of a pre-filter according to an embodiment of the disclosure;

FIG. 22 is a perspective view illustrating an arrangement relationship between a detection module and a magnet in an air purifier, according to an embodiment of the disclosure;

FIG. 23 is an enlarged view of a portion of FIG. 22 according to an embodiment of the disclosure;

FIG. 24 is a front view of FIG. 23 according to an embodiment of the disclosure;

FIG. 25 is a block diagram schematically illustrating a control unit and related components of an air purifier, according to an embodiment of the disclosure;

FIG. 26 is a perspective view illustrating an air purifying apparatus according to an embodiment of the disclosure;

FIG. 27 is an exploded perspective view illustrating an air sterilizer of FIG. 26 according to an embodiment of the disclosure;

FIG. 28 is an exploded perspective view of a portion of the air sterilizer of FIG. 27 according to an embodiment of the disclosure;

FIG. 29 is an exploded perspective view of a connection part of the air purifying apparatus of FIG. 26 according to an embodiment of the disclosure; and

FIG. 30 is a cross-sectional view of the air purifying apparatus of FIG. 26 according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Terms, such as “first” or “second” may be used to describe various elements, but the elements are not limited by the terms. These terms are only used to distinguish one element from another element. For example, a first element may be referred to as a second element, and a second element may be referred to as a first element in a similar manner, without departing from the scope of the disclosure. The term “and/or” includes any and all combinations of one or more of the associated listed items.

Terms used herein are for describing embodiments and are not intended to limit the scope of the disclosure. As used herein, terms, such as “comprises,” “includes,” or “has” specify the presence of stated features, numbers, stages, operations, components, parts, or a combination thereof, but do not preclude the presence or addition of one or more other features, numbers, stages, operations, components, parts, or a combination thereof. Like reference numerals in the drawings indicate members that perform substantially the same functions.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

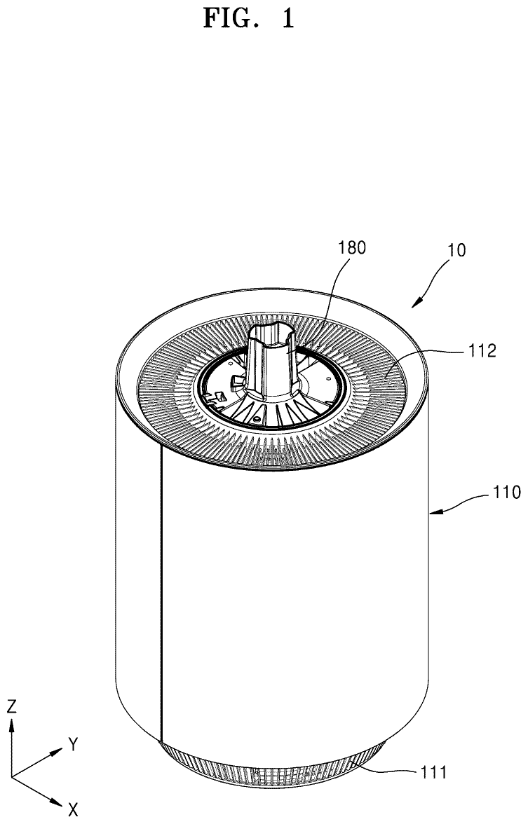

FIG. 1 is a perspective view illustrating an air purifier according to an embodiment of the disclosure.

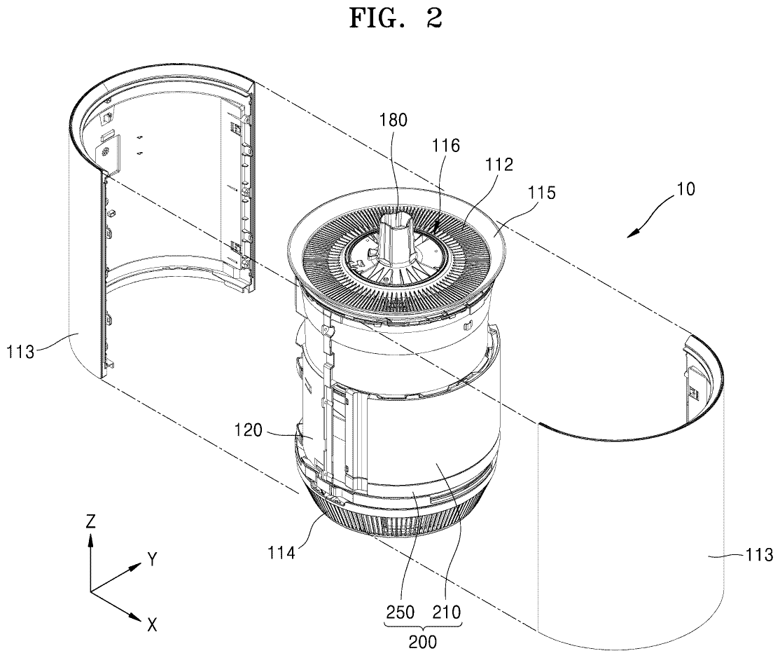

FIG. 2 is an exploded perspective view illustrating an air purifier according to an embodiment of the disclosure.

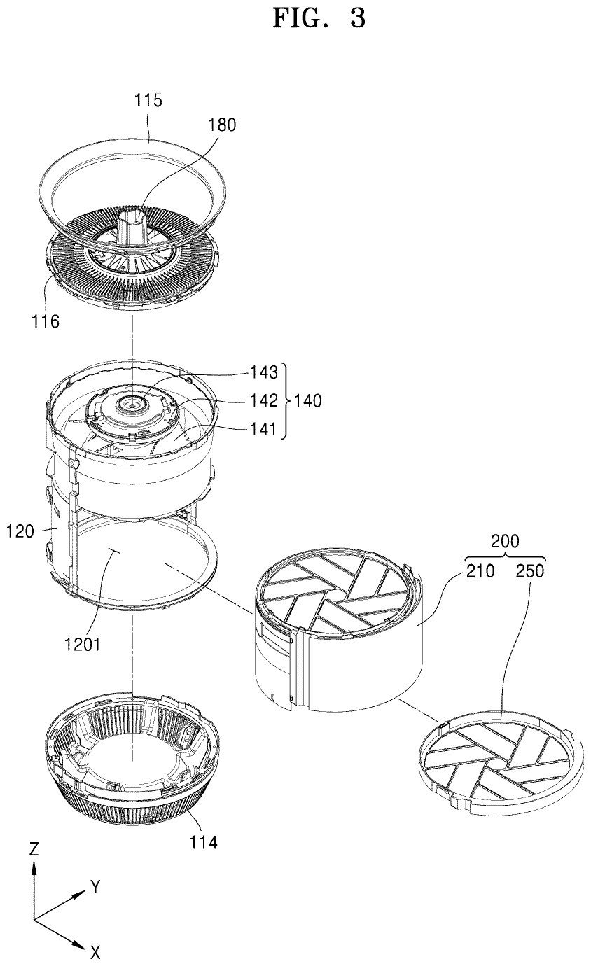

FIG. 3 is an exploded perspective view of a portion of an air purifier according to an embodiment of the disclosure.

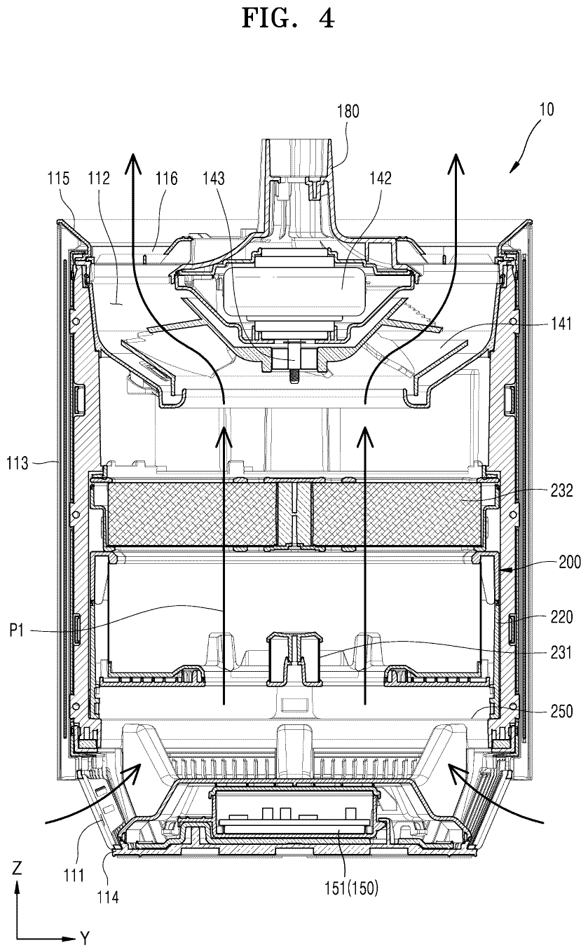

FIG. 4 is a cross-sectional view of an air purifier according to an embodiment of the disclosure.

Referring to FIGS. 1, 2, 3, and 4, the air purifier 10 according to an embodiment may include a housing 110 forming the exterior of the air purifier 10, and an inner frame 120 provided to support various parts inside the housing 110.

The housing 110 has a first flow path P1 provided therein and may be configured to accommodate various parts of the air purifier 10.

The housing 110 may include an introduction port 111 and a discharge port 112. The introduction port 111 may be provided to allow air external to the housing 110 to flow into the housing 110. The discharge port 112 may be provided to allow air inside the housing 110 to be discharged to outside of the housing 110. The first flow path P1 extending from the introduction port 111 to the discharge port 112 may be provided inside the housing 110.

For example, the introduction port 111 may be formed in a lower portion of the housing 110. The discharge port 112 may be formed in an upper portion of the housing 110. At least a portion of the first flow path P1 may extend in a vertical direction, for example, in a Z direction. Accordingly, air introduced into the housing 110 through the introduction port 111 may move upward along the first flow path P1. However, the arrangement of the introduction port 111 and the discharge port 112 is not limited thereto, and the introduction port 111 and the discharge port 112 may be formed at various positions.

The housing 110 may include a housing body 113, a base 114, an upper cover 115, and a discharge port cover 116. The housing body 113, the base 114, the upper cover 115, and the discharge port cover 116 may constitute a portion of the exterior of the air purifier 10.

The housing body 113 may form the side surface of the air purifier 10. The housing body 113 may be provided to cover various parts of the air purifier 10 in a horizontal direction. The housing body 113 may connect the base 114 to the upper cover 115.

The housing body 113 may extend in a direction parallel to the first flow path P1. For example, the housing body 113 may extend in the vertical direction.

The housing body 113 may have a substantially cylindrical shape with a space therein. However, the shape of the housing body 113 is not limited thereto and the housing body 113 may have various shapes depending on the exterior of the air purifier 10.

The housing body 113 may be formed to be divided into a plurality of panels. The plurality of panels may be disassembled and assembled. The housing body 113 may be easily disassembled or assembled, and user accessibility to the components arranged inside the housing 110 may be improved. However, the structure of the housing body 113 is not limited thereto, and the housing body 113 may be formed as a single integral component.

The base 114 may be provided in a lower portion of the housing body 113. The base 114 may form the bottom surface of the air purifier 10. When the air purifier 10 is placed on the ground, the base 114 may support the air purifier 10. The base 114 may be coupled to a lower portion of the housing body 113.

A side surface of the base 114 may be formed in the circumferential direction of the base 114. The side surface of the base 114 may extend in the vertical direction or in a direction having a certain angle with the vertical direction.

The introduction port 111 may be formed in the base 114. The introduction port 111 may be formed on the side surface of the base 114. The introduction port 111 may be arranged along the perimeter of the base 114. The side surface of the base 114 may have a grill shape to facilitate the entry and exit of air.

The upper cover 115 and the discharge port cover 116 may be provided in the upper portion of the housing body 113. The upper cover 115 and the discharge port cover 116 may form the upper surface of the air purifier 10. The upper cover 115 and the discharge port cover 116 may be formed to cover the internal space of the housing 110 from above. The upper cover 115 may be provided to form a portion of the upper surface of the housing 110, and the discharge port cover 116 may be provided to cover another portion of the upper surface of the housing 110.

The discharge port cover 116 may have a grill shape to allow air to enter and exit through the discharge port 112. The grill shape may be arranged along the perimeter of the upper surface of the housing 110. However, the arrangement of the grill shape is not limited thereto and may vary.

The upper cover 115 may be arranged along the perimeter of the discharge port cover 116. The upper cover 115 may be coupled to an edge of the discharge port cover 116. The upper cover 115 may be arranged outside the edge of the discharge port cover 116.

The inner frame 120 may be arranged inside the housing 110. The inner frame 120 may be coupled to the inner surface of the housing 110. The inner frame 120 may support the inner surface of the housing 110.

The inner frame 120 may be provided to support various parts of the air purifier 10. The parts of the air purifier 10, such as a filter assembly 200 or a fan 140 may be supported by the inner frame 120.

The inner frame 120 may be covered by the housing 110. For example, the side of the inner frame 120 in the horizontal direction may be covered by the housing body 113. The bottom of the inner frame 120 in the vertical direction may be covered by the base 114. The top of the inner frame 120 in the vertical direction may be covered by the upper cover 115 and the discharge port cover 116.

The inner frame 120 may be formed to be divided into a plurality of frames. The plurality of frames constituting the inner frame 120 may be formed to integrally form the inner frame 120 in a state in which the plurality of frames are coupled to each other. Accordingly, disassembly or assembly of the inner frame (120) may be facilitated. However, the structure of the inner frame 120 is not limited thereto, and the inner frame 120 may be formed as a single integral component.

A space having a substantially cylindrical shape may be formed inside the inner frame 120. The filter assembly 200, the fan 140, and the like may be arranged in the internal space of the inner frame 120. The first flow path P1 may be provided in the internal space of the inner frame 120. The inner frame 120 may cover an outer side of the first flow path P1.

However, the shape of the inner frame 120 is not limited thereto and the inner frame 120 may have various shapes. For example, the space formed inside the inner frame 120 may have a shape other than the cylindrical shape.

The air purifier 10 according to an embodiment may include the fan 140 arranged inside the housing 110. The fan 140 may be provided in the first flow path P1. The fan 140 may be arranged between the introduction port 111 and the discharge port 112. As the fan 140 rotates, an air flow may be generated in a direction from the introduction port 111 toward the discharge port 112. Accordingly, external air of the housing 110 may be introduced through the introduction port 111, and the introduced air may move along the first flow path P1 to be discharged through the discharge port 112.

The fan 140 may be configured as an axial-flow type. The fan 140 may include a blade 141, a motor 142 that supplies power to the blade 141, and a fan rotation shaft 143 that is connected to the blade 141 and the motor 142 to transmit power generated by the motor 142 to the blade 141. However, the type and configuration of the fan 140 are not limited thereto and may be modified as needed. For example, the fan 140 may be configured as a centrifugal type.

The fan 140 may be arranged between the filter assembly 200 and the discharge port 112. When the fan 140 is driven, air introduced into the introduction port 111 may sequentially pass through the filter assembly 200 and the fan 140 and be then discharged through the discharge port 112. However, the arrangement of the fan 140 is not limited thereto and may vary. For example, unlike the drawings, the fan 140 may be arranged between the introduction port 111 and the filter assembly 200.

The filter assembly 200 may remove foreign substances from the air introduced into the housing 110. The filter assembly 200 may be provided in the first flow path P1. When the fan 140 is driven, the air introduced through the introduction port 111 may move along the first flow path P1 and pass through the filter assembly 200. Foreign substances in the air moving along the first flow path P1 may be removed by the filter assembly 200. The air from which the foreign substances have been removed by the filter assembly 200 may be discharged through the discharge port 112.

The filter assembly 200 may have a shape corresponding to the shape of the housing 110. For example, the filter assembly 200 may have a cylindrical structure. However, the shape of the filter assembly 200 is not limited thereto and may vary depending on the shape of the housing 110.

The filter assembly 200 may include a dust collection filter 210 and a pre-filter 250.

The pre-filter 250 may be provided in the first flow path P1. The pre-filter 250 may be arranged on a flow path that is toward the dust collection filter 210. The pre-filter 250 may be arranged between the introduction port 111 and the dust collection filter 210, in the first flow path P1.

The pre-filter 250 may be provided to primarily collect foreign substances in air sucked in through the introduction port 111. The pre-filter 250 may be provided to separate relatively large foreign substances from air. For example, the pre-filter 250 may be configured to filter out foreign substances of a first size.

The dust collection filter 210 may be provided in the first flow path P1. The dust collection filter 210 may be arranged downstream of the pre-filter 250 in the first flow path P1. The dust collection filter 210 may be provided to separate foreign substances that are smaller than foreign substances separated by the pre-filter 250. For example, the dust collection filter 210 may be configured to filter out foreign substances of a second size smaller than the first size.

The dust collection filter 210 may include an electric dust collection filter 230 configured to collect dust by using electrostatic force. When power is applied to the electric dust collection filter 230, an electric field may be formed in the electric dust collection filter 230. Foreign substances in air, such as dust, may be collected by the electric field formed in the electric dust collection filter 230. In addition, organic substances, such as bacteria or viruses may be decomposed by the electric field formed in the electric dust collection filter 230. For example, the electric dust collection filter 230 may perform dust collection and sterilization functions.

The electric dust collection filter 230 may include a charging unit 231 and a dust collection unit 232.

The charging unit 231 may be arranged to charge foreign substances in air. The charging unit 231 may be provided in an upper portion of the pre-filter 250 to charge foreign substances in air that has passed through the pre-filter 250. In other words, the charging unit 231 may be arranged downstream of the pre-filter 250 in the first flow path P1.

The dust collection unit 232 may be provided to collect the foreign substances charged by the charging unit 231. Electrodes having different polarities may be connected to the charging unit 231 and the dust collection unit 232, respectively. An electric field may be formed between the charging unit 231 and the dust collection unit 232. The foreign substances in the air that are charged by the charging unit 231 may be charged with the same polarity as that of the charging unit 231 and may be charged with the opposite polarity to that of the dust collection unit 232. Accordingly, the foreign substances in the air that are charged by the charging unit 231 may be moved to the dust collection unit 232 by electric force and then collected by the dust collection unit 232. In addition, organic substances, such as bacteria or viruses floating in the air may be decomposed by the electric force.

The dust collection unit 232 may be provided on one side of the electric dust collection filter 230, and the dust collection unit 232 may be provided on the other side of the electric dust collection filter 230. The charging unit 231 and the dust collection unit 232 may be arranged to face each other. For example, the charging unit 231 and the dust collection unit 232 may be arranged to face each other in the vertical direction. The dust collection unit 232 may be provided in an upper portion of the electric dust collection filter 230, and the charging unit 231 may be provided in a lower portion of the electric dust collection filter 230. The dust collection unit 232 may be arranged downstream of the charging unit 231 in the first flow path P1. The charging unit 231 may be arranged between the dust collection unit 232 and the introduction port 111. The dust collection unit 232 may be arranged between the charging unit 231 and the discharge port 112.

The pre-filter 250 may be arranged between the introduction port 111 and the electric dust collection filter 230. In other words, the electric dust collection filter 230 may be arranged between the discharge port 112 and the pre-filter 250.

The above-described embodiment of the disclosure, an example is mainly described in which the dust collection filter 210 includes the electric dust collection filter 230, but the disclosure is not limited thereto, and the dust collection filter 210 may further include another dust collection filter or may include another dust collection filter instead. For example, the dust collection filter 210 may include various filters, such as a high-efficiency particulate air (HEPA) filter.

The air purifier 10 may include a control unit 150 for controlling the operation of the air purifier 10. The control unit 150 may include a first printed circuit board assembly 151. The first printed circuit board assembly 151 may be configured to control the operation of the air purifier 10. The first printed circuit board assembly 151 may be formed by mounting electronic components for controlling the operation of the air purifier 10 on a printed circuit board. The control unit 150 may be electrically connected to various parts, such as the fan 140, the electric dust collection filter 230, or a detection module 130 to be described below.

In addition, the filter assembly 200 may require periodic cleaning or replacement to remove foreign substances collected in at least one of the pre-filter 250 and the dust collection filter 210. However, the cleaning cycles of the pre-filter 250 and the dust collection filter 210 may be different from each other. For example, the cleaning cycle of the pre-filter 250 may be shorter than the cleaning cycle of the dust collection filter 210. For example, in a case in which the cleaning cycle of the pre-filter 250 is about once a week, the cleaning cycle of the dust collection filter 210 may be about once every six months.

As such, considering that the cleaning cycles of the pre-filter 250 and the dust collection filter 210 included in the filter assembly 200 are different from each other, the filter assembly 200 may be configured to be detachably mounted on the inner frame 120.

The air purifier 10 according to an embodiment may be configured to allow the pre-filter 250 to be selectively detached from the air purifier 10 or allow both the pre-filter 250 and the dust collection filter 210 to be detached from the air purifier 10 at once.

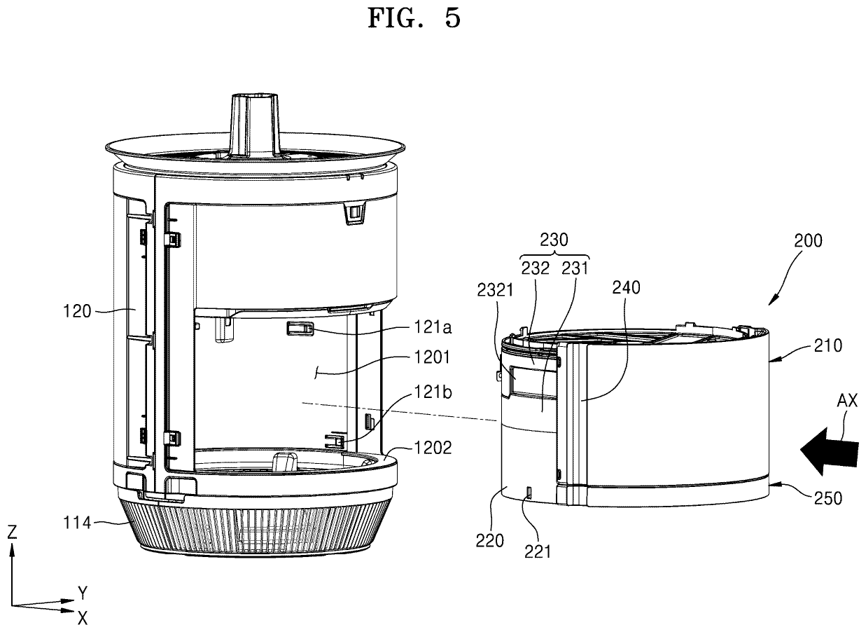

FIG. 5 is a perspective view illustrating a state in which a filter assembly is detached from an air purifier according to an embodiment of the disclosure.

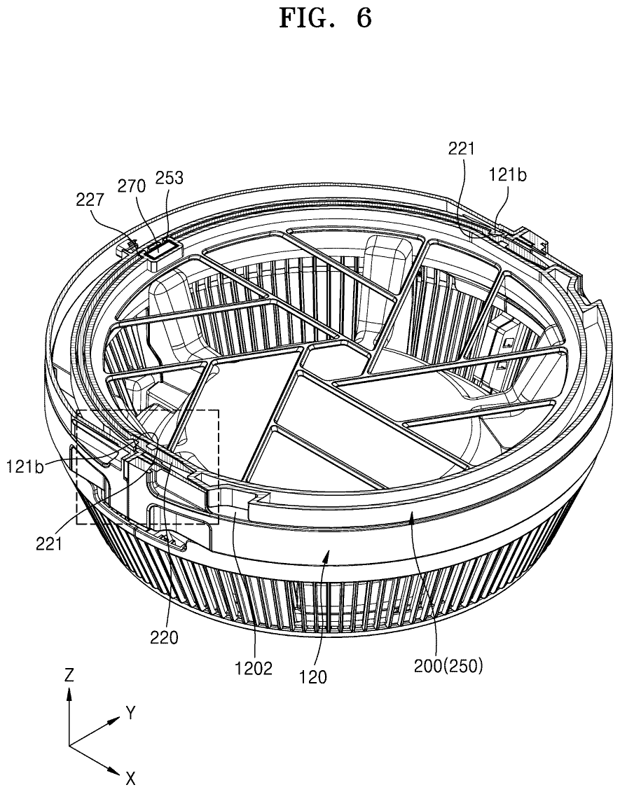

FIG. 6 is a cross-sectional perspective view illustrating a state in which a filter assembly is mounted on an inner frame of an air purifier according to an embodiment of the disclosure.

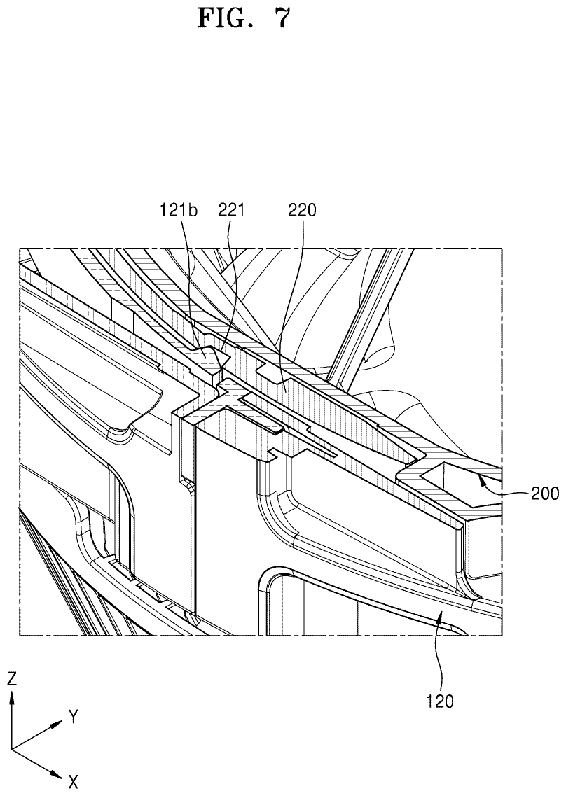

FIG. 7 is an enlarged view of a portion of an air purifier of FIG. 6 according to an embodiment of the disclosure.

Referring to FIG. 5, one side surface of the inner frame 120 of the air purifier 10 according to an embodiment may be open to allow mounting and detachment of the filter assembly 200. An open surface 1201 through which the filter assembly 200 passes when mounting or detaching the filter assembly 200 may be formed on one side surface of the inner frame 120.

The inner frame 120 may provide a seating surface 1202 for mounting the filter assembly 200. The seating surface 1202 may be arranged to define a portion of the open surface 1201 or to be adjacent to the open surface 1201. When inserting the filter assembly 200 into the open surface 1201 of the inner frame 120, the filter assembly 200 may be easily positioned and inserted through the seating surface 1202.

The seating surface 1202 may extend in a direction parallel to a mounting direction AX of the filter assembly 200. Accordingly, while the filter assembly 200 is mounted or detached, the filter assembly 200 may be mounted or detached along the seating surface 1202 in the mounting direction AX or in the direction opposite to the mounting direction AX. The seating surface 1202 may provide a function of guiding a movement of the filter assembly 200 being mounted or detached.

Through the open surface 1201, the filter assembly 200 inserted into the inner frame 120 may have a certain mounting position with respect to the inner frame 120. For example, the filter assembly 200 may be aligned on the first flow path P1. For example, the center of the filter assembly 200 may be aligned with the center of the air purifier 10.

The inner frame 120 and the filter assembly 200 may have a hook-coupling structure configured to maintain the mounting position of the filter assembly 200 with respect to the inner frame 120. Thus, the filter assembly 200 may be fixed to a predetermined mounting position inside the inner frame 120 through an operation of inserting the filter assembly 200 into the inner frame 120 without a separate fastening process.

As an example of the hook-coupling structure of the inner frame 120 and the filter assembly 200, first hooks 121a and 121b may be provided in any one of the inner frame 120 and the filter assembly 200, and first grooves 2321 and 221 into which the first hooks 121a and 121b) are inserted, respectively, may be provided in the other of the inner frame 120 and the filter assembly 200.

For example, the first hooks 121a and 121b that are elastically deformable may be provided on the inner surface of the inner frame 120, and the first groove 2321 and 221 may be provided on the outer surface of the filter assembly 200. A plurality of first grooves 2321 and 221 and a plurality of first hooks 121a and 121b may be provided and may have different heights. However, the numbers and arrangement of first grooves 2321 and 221 and first hooks 121a and 121b are not limited thereto and may be variously modified.

The dust collection filter 210 may include a filter case 220 for supporting at least a portion of the electric dust collection filter 230. In other words, at least a portion of the electric dust collection filter 230 may be provided in the filter case 220.

The filter case 220 may support the pre-filter 250. The filter case 220 may be configured to allow the pre-filter 250 to be detachably mounted thereon. A configuration for mounting the pre-filter 250 will be described below.

A first groove 221 may be provided on the outer surface of the filter case 220. The first groove 221 may be arranged in an area in the filter case 220 provided to surround the pre-filter 250. Another first groove 2321 may be provided on the outer surface of the electric dust collection filter 230. For example, the other first groove 2321 may be provided on the outer surface of the dust collection unit 232 of the electric dust collection filter 230.

Referring to FIGS. 5, 6, and 7, the filter assembly 200 may be pressed in the mounting direction AX in a state in which the filter assembly 200 is inserted through the open surface 1201 of the inner frame 120. As the filter assembly 200 is pressed, the first hooks 121a and 121b of the inner frame 120 may be inserted into the first grooves 2321 and 221 provided on the outer surface of the filter assembly 200, respectively. During a process of inserting the first hooks 121a and 121b into the first grooves 2321 and 221, respectively, the first hooks 121a and 121b may be elastically deformed. Accordingly, the filter assembly 200 may be completely mounted on the inner frame 120 and may be fixed to maintain the mounting position with respect to the inner frame 120.

A handle 240 for detaching the filter assembly 200 may be provided in the filter case 220. The handle 240 may be provided on both sides in the mounting direction. A user may easily detach the filter assembly 200 from the inner frame 120 of the air purifier 10 by holding the handle 240 and pulling it in the opposite direction to the mounting direction.

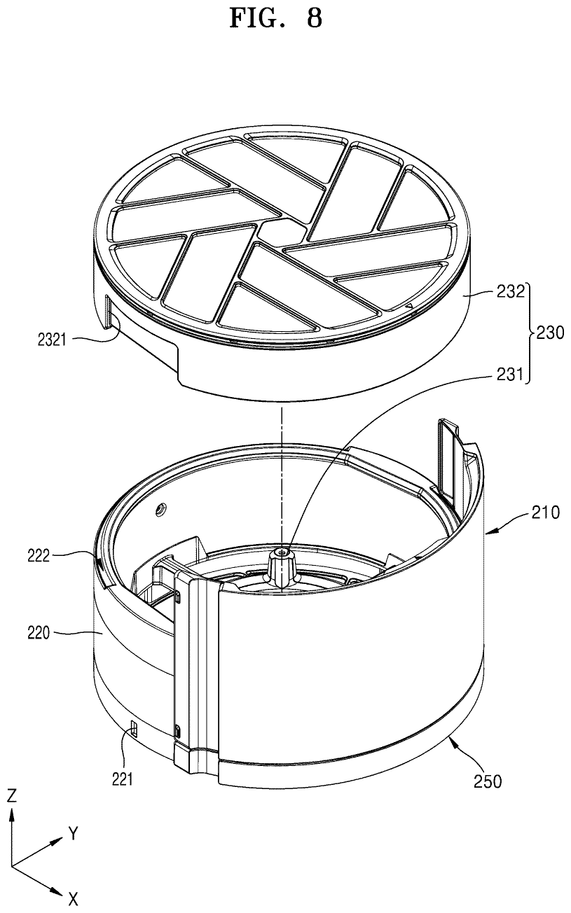

FIG. 8 is an exploded perspective view of a filter assembly according to an embodiment of the disclosure.

Referring to FIG. 8, the filter case 220 of the filter assembly 200 according to the embodiment may be configured such that at least a portion of the electric dust collection filter 230 is detachable. For example, the charging unit 231 of the electric dust collection filter 230 may be fixed to the filter case 220, and the dust collection unit 232 of the electric dust collection filter 230 may be mounted and detached from the filter case 220. The dust collection unit 232 is where dust is collected in the electric dust collection filter 230, and thus may be periodically detached to be cleaned.

For example, the dust collection unit 232 may be mounted on the filter case 220 in a direction different from the mounting direction of the filter assembly 200. For example, the dust collection unit 232 may be mounted and detached in a direction perpendicular to the mounting direction of the filter assembly 200, for example, in the vertical direction. For example, the dust collection unit 232 may be mounted on the filter case 220 in the downward direction. For example, the dust collection unit 232 may be detached from the filter case 220 in the upward direction.

A seating groove 222 in which the dust collection unit 232 is seated may be provided in the filter case 220. When the dust collection unit 232 is mounted on the filter case 220, an edge of the dust collection unit 232 may be seated in the seating groove 222. The dust collection unit 232 seated on the filter case 220 is restricted from moving in the mounting direction of the filter assembly 200. Accordingly, in a process of detaching the filter assembly 200 from the inner frame 120, the dust collection unit 232 may be prevented from being unintentionally separated from the filter case 220.

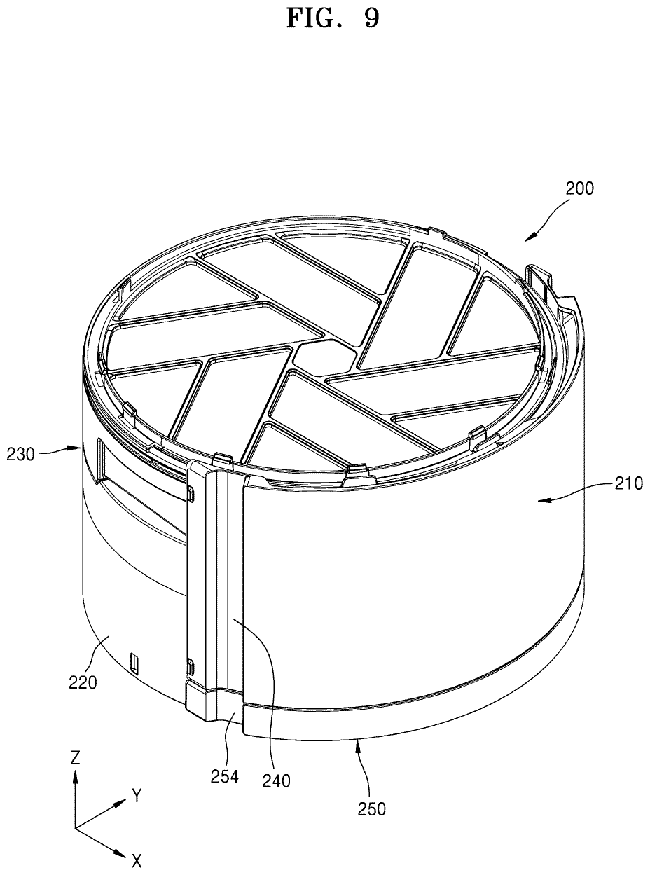

FIG. 9 is a perspective view illustrating an assembled filter assembly according to an embodiment of the disclosure.

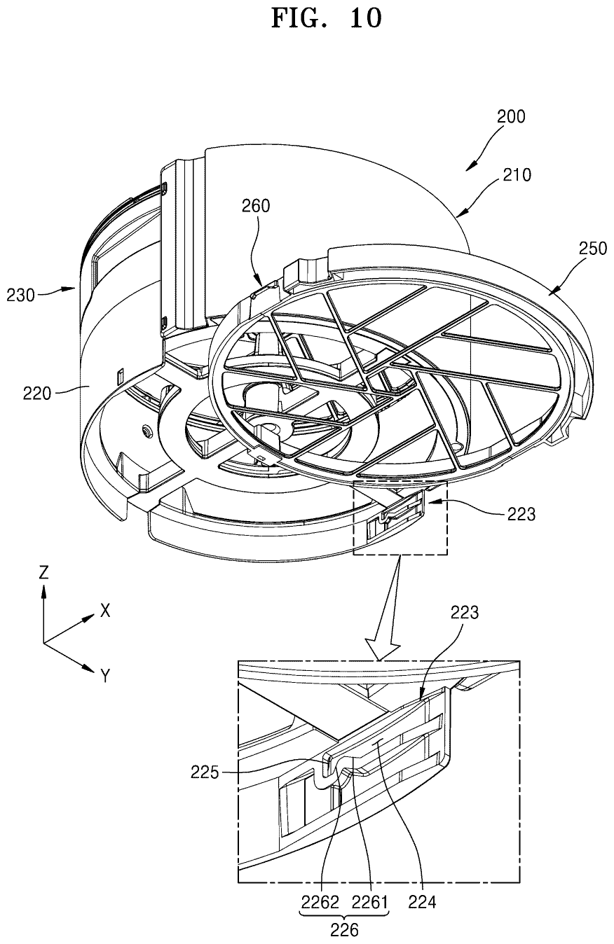

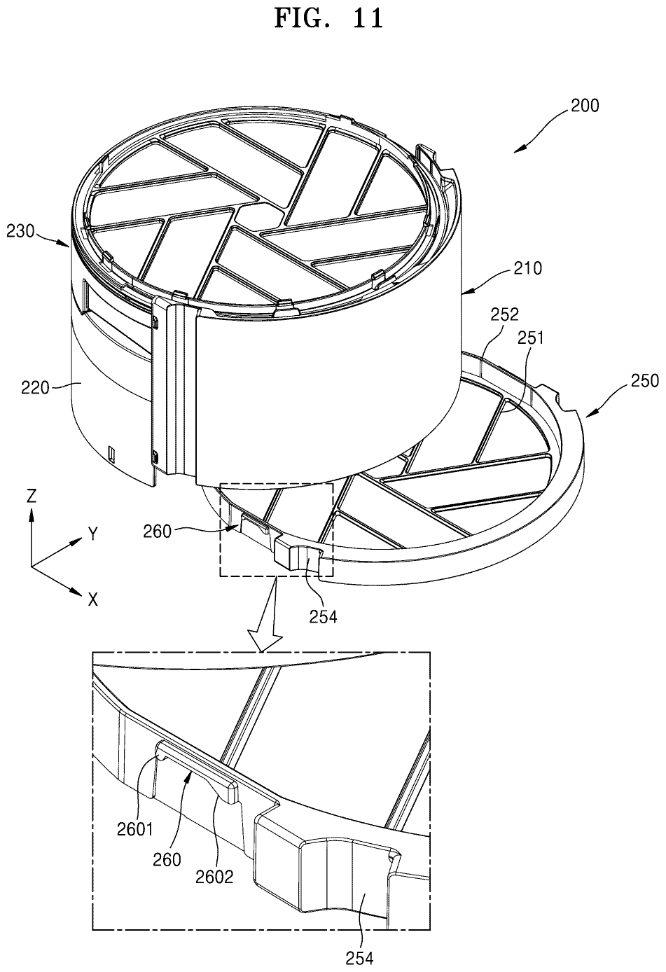

FIGS. 10 and 11 are perspective views illustrating a pre-filter detached from a filter assembly of FIG. 9, seen from different angles, according to various embodiments of the disclosure.

Referring to FIGS. 9, 10, and 11, the pre-filter 250 may be detachably mounted on the filter assembly 200. The pre-filter 250 may be detachably mounted on the dust collection filter 210 in a direction parallel to the mounting direction of the filter assembly 200. The mounting direction of the pre-filter 250 and the mounting direction of the filter assembly 200 may be the same as or parallel to each other.

To ensure that the pre-filter 250 is mounted on or detached from the dust collection filter 210 in a certain direction, the dust collection filter 210 may include guide units 223 that guides a movement of the pre-filter 250 being mounted or detached.

The guide units 223 may be arranged on the inner circumferential surface of the filter case 220 of the dust collection filter 210. The guide units 223 may be provided on both sides of the inner circumferential surface of the filter case 220 in the mounting direction of the pre-filter 250. The guide unit 223 may be provided in a groove shape on the inner circumferential surface of the filter case 220. At least a portion of the guide unit 223 may extend in the mounting direction of the pre-filter 250.

Guide protrusions 260 to be inserted into the guide units 223, respectively, may be provided on the outer side surface of the pre-filter 250. The pre-filter 250 may include a filter area 251 for removing foreign substances from air, and a frame area 252 surrounding the filter area 251.

The guide protrusions 260 may be provided on the outer circumferential surface of the frame area 252. The guide protrusions 260 may be provided on both sides of the outer circumferential surface of the frame area 252 in the mounting direction of the pre-filter 250. The guide protrusion 260 may protrude in a radial direction from the outer circumferential surface of the frame area 252. In other words, the guide protrusion 260 may protrude from the outer circumferential surface of the frame area 252 in a direction perpendicular to the mounting direction of the pre-filter 250.

The guide protrusion 260 may extend in the mounting direction. The guide protrusion 260 may include a front protrusion 2601 arranged in a front portion of the guide protrusion 260 in the mounting direction, and a rear protrusion 2602 arranged at the rear of the front protrusion 2601. The front protrusion 2601 may serve to restrict movement of the guide protrusion 260 by being caught by a stopper 226 to be described below, and the rear protrusion 2602 may serve to guide the movement of the guide protrusion 260 by coming into contact with the guide unit 223.

The stopper 226 that restricts movement of the guide protrusion 260 may be provided in the guide unit 223. The stopper 226 may be provided to restrict movement of the front protrusion 2601 of the guide protrusion 260. When the pre-filter 250 is inserted into the filter case 220 in the mounting direction and reaches a predetermined mounting position, the stopper 226 may maintain the pre-filter 250 in the mounting position by restricting movement of the guide protrusion 260. When the pre-filter 250 reaches the mounting position with respect to the filter case 220, movement of the front protrusion 2601 of the guide protrusion 260 may be restricted by the stopper 226.

The guide unit 223 may include a guide area 224 that guides the movement of the guide protrusion 260, and a locking area 225 that maintains the position of the guide protrusion 260. The stopper 226 may be arranged between the guide area 224 and the locking area 225. The stopper 226 has a first inclined surface 2261 facing the guide area 224, and a second inclined surface 2262 facing the locking area 225. The inclined surface of the second inclined surface 2262 may be greater than the inclination angle of the first inclined surface 2261. The stopper 226 may make a movement of the guide protrusion 260 from the locking area 225 to the guide area 224 relatively difficult, while make a movement of the guide protrusion 260 from the guide area 224 to the locking area 225 relatively easy.

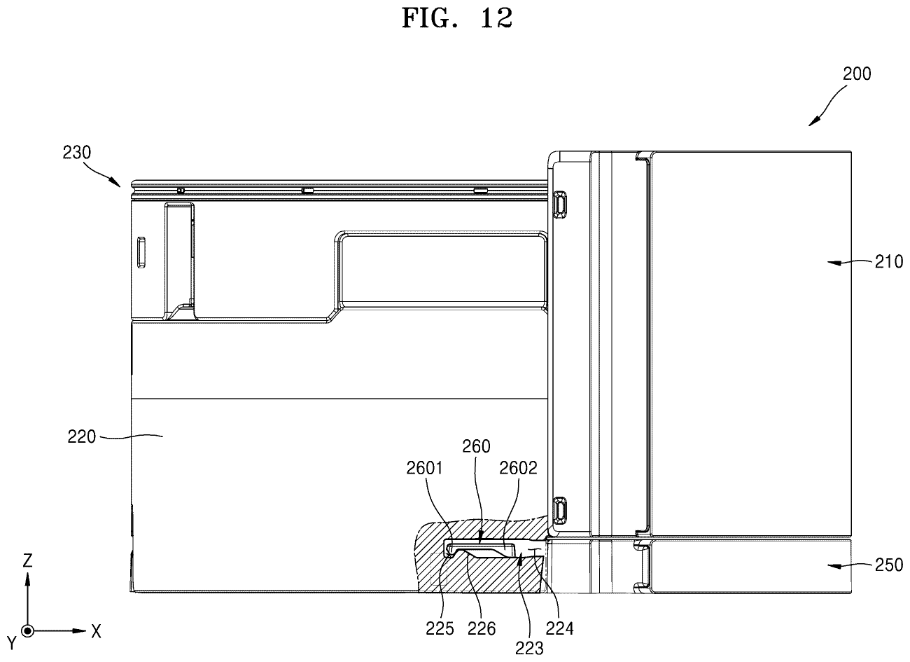

FIG. 12 is a side view illustrating a state in which a pre-filter is mounted on a dust collection filter in a filter assembly according to an embodiment of the disclosure.

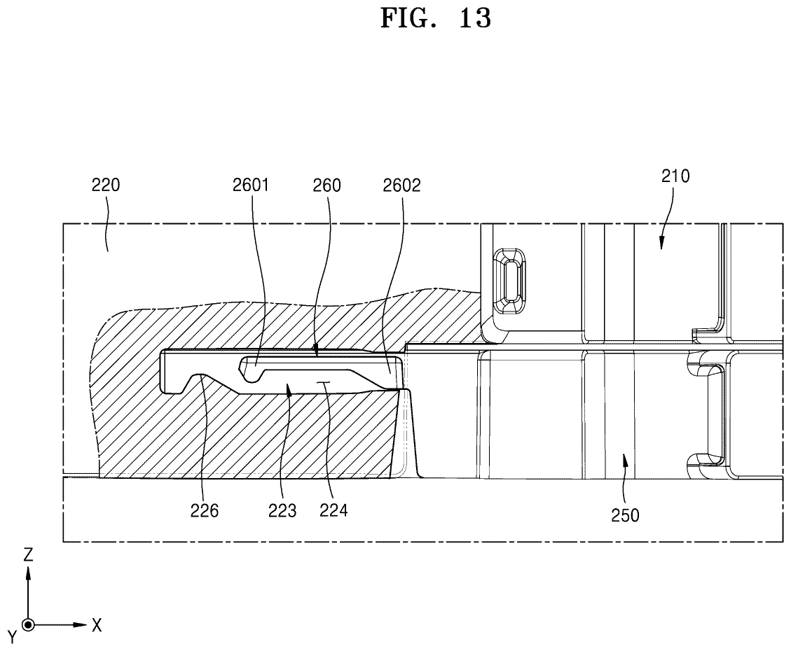

FIGS. 13, 14, and 15 are diagrams illustrating a movement of the guide protrusion 260 in the second guide unit 223 when the pre-filter 250 moves in the mounting direction according to various embodiments of the disclosure.

Referring to FIGS. 10, 11, and 12, the pre-filter 250 may be mounted on the filter assembly 200 in the mounting direction. In a process of mounting the pre-filter 250, the guide protrusion 260 of the pre-filter 250 moves along the guide unit 223 provided on the inner circumferential surface of the filter case 220, such that the mounting may be completed at a predetermined position.

In the mounting process, as illustrated in FIG. 13, in order to mount the pre-filter 250 on the dust collection filter 210, the guide protrusion 260 may be inserted into the guide area 224 of the guide unit 223. At this time, the guide protrusion 260 inserted into the guide area 224 of the guide unit 223 may be in contact with the lower surface of the guide unit 223. For example, the lower surface of the rear protrusion 2602 of the guide protrusion 260 may be in contact with and supported by the lower surface of the guide unit 223. Accordingly, when the pre-filter 250 is pressed in the mounting direction, the guide protrusion 260 moves along the lower surface of the guide area 224 of the guide unit 223.

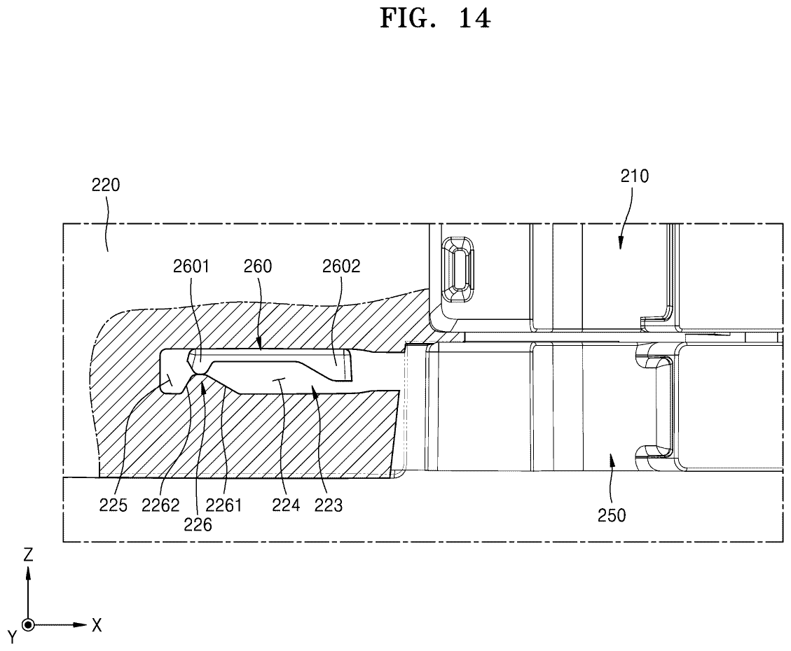

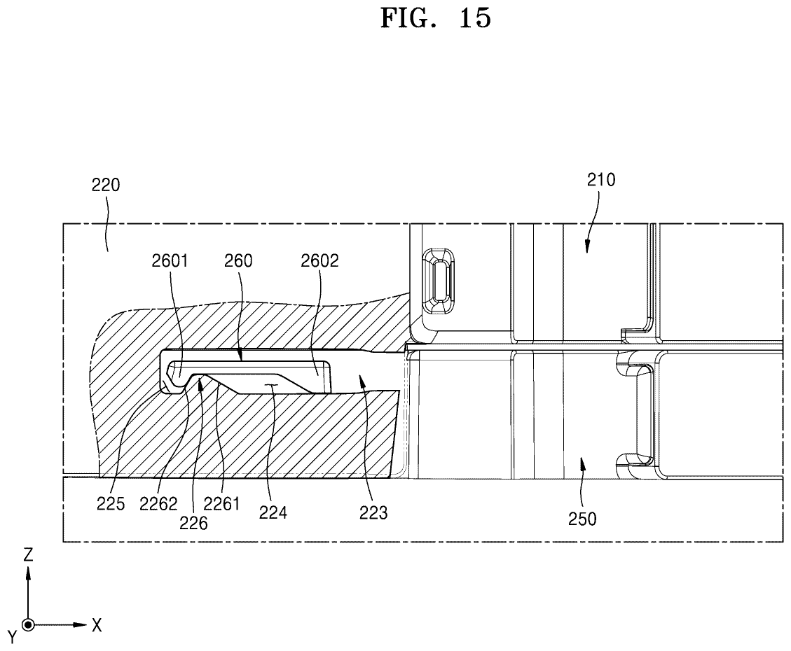

As the pre-filter 250 is additionally pressed in the mounting direction, as illustrated in FIG. 14, the front protrusion 2601 of the guide protrusion 260 crosses the stopper 226 of the guide unit 223. As illustrated in FIG. 15, the front protrusion 2601 of the guide protrusion 260 passes through the first inclined surface 2261 and the second inclined surface 2262 of the stopper 226, and then reaches the locking area 225. As the front protrusion 2601 of the guide protrusion 260 is positioned in the locking area 225 of the guide unit 223, the mounting of the pre-filter 250 may be completed.

Referring again to FIGS. 3 and 9, the pre-filter 250 may have a handle 254. The pre-filter 250 may be detached from the dust collection filter 210 of the filter assembly 200 by the user holding the handle 254 and pulling it in the opposite direction to the mounting direction.

When the handle 254 of the pre-filter 250 is pulled, the guide protrusion 260 moves in the opposite direction to when the pre-filter 250 is mounted on the dust collection filter 210. In this case, the guide protrusion 260 may move sequentially as illustrated in FIGS. 15, 14, and 13. The front protrusion 2601 of the guide protrusion 260 may move along the second inclined surface 2262 and the first inclined surface 2261 of the stopper 226, such that the guide protrusion 260 is detached from the guide unit 223. Accordingly, the pre-filter 250 may be detached separately from the dust collection filter 210. As such, because the pre-filter 250 may be detached independently of the dust collection filter 210, the user may separately detach the pre-filter 250 to replace or wash it.

By means of the filter assembly 200 having the above-described configuration, the user may selectively detach a plurality of filters as needed. For example, when the pre-filter 250 with a relatively short cleaning cycle is to be detached, the pre-filter 250 may be selectively detached by pulling the handle 254 of the pre-filter 250, without detaching the dust collection filter 210. For example, when both the dust collection filter 210 and the pre-filter 250 are to be detached, the dust collection filter 210 and the pre-filter 250 may be detached from the inner frame 120 at once by pulling the handle 240 of the dust collection filter 210 to detach the filter assembly 200. After detaching the filter assembly 200 from the inner frame 120, the user may detach the dust collection unit 232 of the dust collection filter 210 from the filter case 220 in a direction perpendicular to the detachment direction of the filter assembly 200, and may detach the pre-filter 250 from the filter case 220 in a direction parallel to the detachment direction of the filter assembly 200 by pulling the handle 254 of the pre-filter 250.

In addition, in some cases, after the detachment of the filter assembly 200, the filter assembly 200 may be mounted on the inner frame 120 without mounting the dust collection unit 232 of the dust collection filter 210 or the pre-filter 250. For example, after detaching the pre-filter 250 from the filter assembly 200, the user may mount the pre-filter 250 on the inner frame 120 rather than on the filter assembly 200, and then operate the air purifier 10. In this case, the performance of the air purifier 10 may deteriorate, the lifespan of the filter may be reduced, or an accident, such as electric shock may occur.

For addressing such issues, the air purifier 10 according to the embodiment may include the detection module 130 configured to detect whether the filter assembly 200 is mounted.

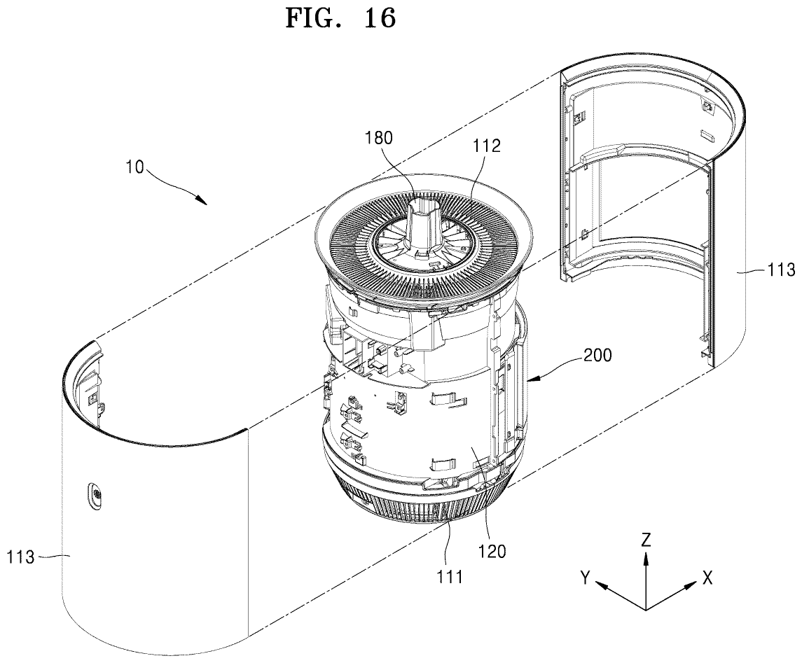

FIG. 16 is an exploded perspective view illustrating an air purifier according to an embodiment of the disclosure.

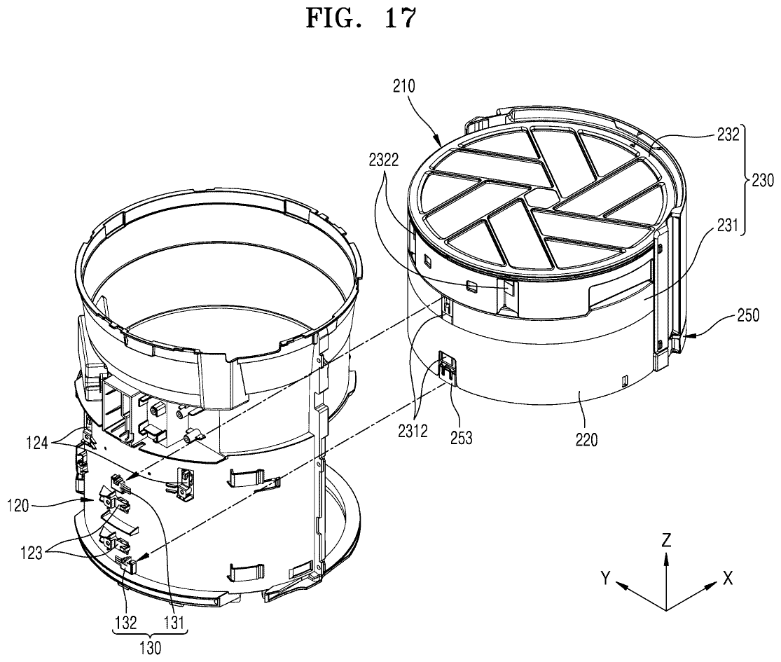

FIG. 17 is an exploded perspective view illustrating a state in which a filter assembly is detached from an inner frame in an air purifier according to an embodiment of the disclosure.

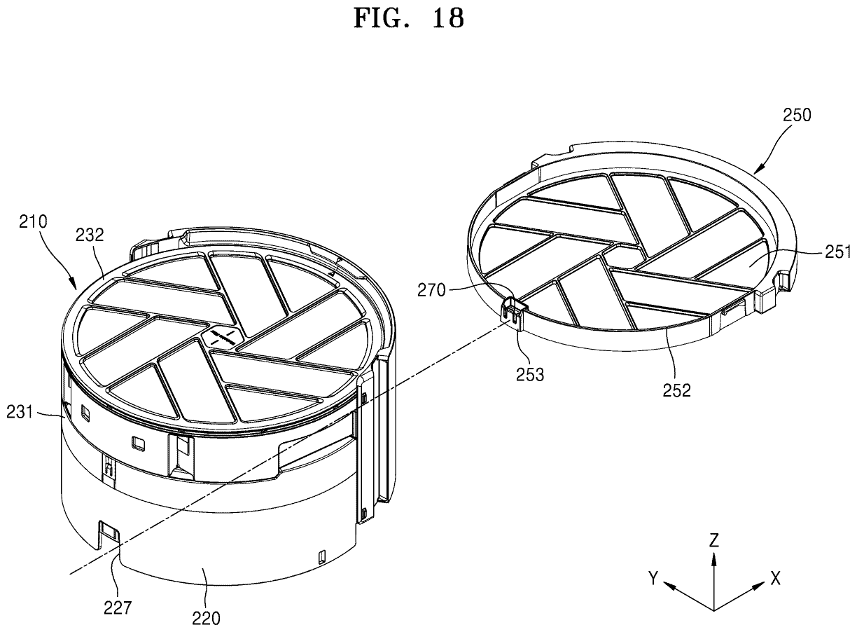

FIG. 18 is an exploded perspective view illustrating a state in which a pre-filter is detached from a filter assembly according to an embodiment of the disclosure.

Referring to FIGS. 16, 17, and 18, the detection module 130 may be arranged in the inner frame 120 of the air purifier 10 according to an embodiment. The detection module 130 may include a first sensor 131 provided in the inner frame 120 to detect whether the dust collection filter 210 is mounted, and a second sensor 132 provided in the inner frame 120 to detect whether the pre-filter 250 is mounted.

The inner frame 120 may include first electrodes 123 and second electrodes 124 for electrical connection with the filter assembly 200. The first electrodes 123 may be electrically connected to the charging unit 231 of the electric dust collection filter 230, and the second electrodes 124 may be electrically connected to the dust collection unit 232 of the electric dust collection filter 230. When the filter assembly 200 is mounted on the inner frame 120, the first electrodes 123 may come into contact with electrodes 2312 of the charging unit 231, and the second electrodes 124 may come into contact with electrodes 2322 of the dust collection unit 232, such that power is supplied to the electric dust collection filter 230.

The detection module 130 may be a magnetic sensor configured to detect a magnetic force. The first sensor 131 and the second sensor 132 may be magnetic sensors. The dust collection filter 210 may include a magnet 233 arranged to face the first sensor 131. The pre-filter 250 may include a magnet 270 arranged to face the second sensor 132.

The frame area 252 of the pre-filter 250 may include a protruding portion 253 that protrudes in a radial direction toward the second sensor 132. The magnet 270 may be arranged inside the protruding portion 253.

The filter case 220 of the dust collection filter 210 may include an opening 227 into which the protruding portion 253 of the pre-filter 250 is inserted such that the protruding portion 253 is exposed toward the second sensor 132. When the pre-filter 250 is mounted, the opening 227 may allow the magnet 270 arranged inside the protruding portion 253 to be positioned close to the second sensor 132.

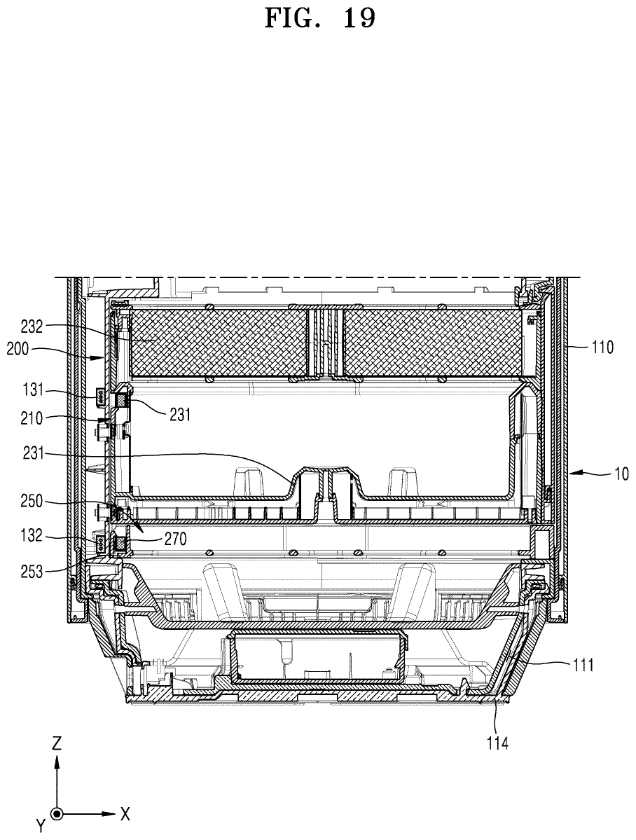

FIG. 19 is a cross-sectional view illustrating a state in which a pre-filter is mounted in an air purifier according to an embodiment of the disclosure.

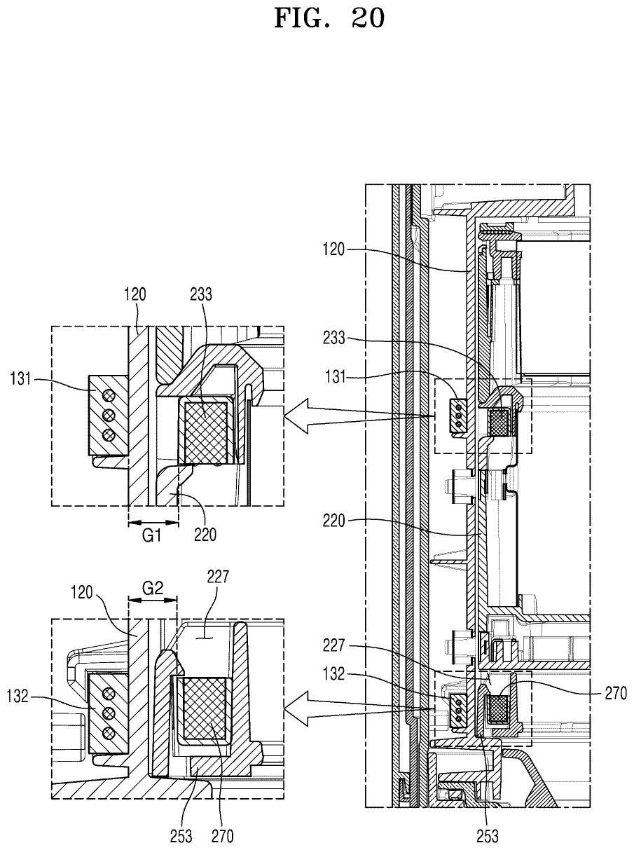

FIG. 20 is a diagram illustrating a distance between a magnet and a second sensor in a state in which a pre-filter is mounted in an air purifier of FIG. 19 according to an embodiment of the disclosure.

Referring to FIGS. 19 and 20, a distance G2 between the magnet 270 and the second sensor 132 may correspond to a distance G1 between the magnet 233 of the dust collection filter 210 and the first sensor 131. For example, the distance G2 between the magnet 270 and the second sensor 132 may be equal to the distance G1 between the magnet 233 of the dust collection filter 210 and the first sensor 131. For example, even when there is a difference between the distance G2 between the magnet 270 and the second sensor 132, and the distance G1 between the magnet 233 of the dust collection filter 210 and the first sensor 131, the difference may be less than the thickness of the filter case 220.

In a case in which the protruding portion 253 of the pre-filter 250 and the opening 227 of the filter case 220 are not provided, the filter case 220 of the dust collection filter 210 is present between the magnet 270 provided in the pre-filter 250 mounted on the dust collection filter 210 and the second sensor 132. Due to the presence of the filter case 220, the sensitivity of the second sensor 132 detecting the magnet 270 may be reduced, and the distance between the magnet 270 and the second sensor 132 may increase by the thickness of the filter case 220, which also reduces the sensitivity of the second sensor 132.

In contrast, in the air purifier 10 according to an embodiment of the disclosure, due to the protruding portion 253 of the pre-filter 250 and the opening 227 of the filter case 220, the filter case 220 is not present between the magnet 270 and the second sensor 132, and the distance G2 between the magnet 270 and the second sensor 132 is short, ensuring the sensitivity of the second sensor 132. Accordingly, detection errors of the second sensor 132 may be prevented.

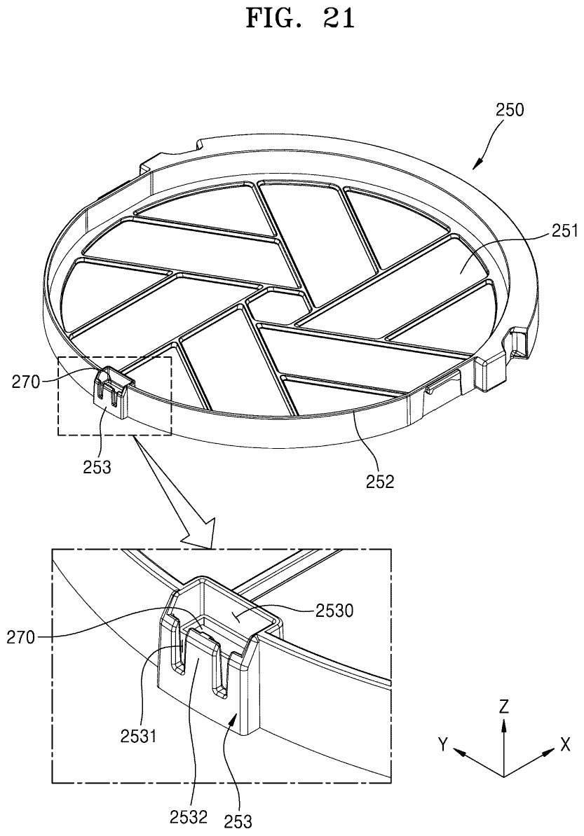

FIG. 21 is a diagram illustrating a protruding portion 253 of a pre-filter 250 according to an embodiment of the disclosure.

Referring to FIGS. 18 and 21, the protruding portion 253 of the pre-filter 250 according to an embodiment may have a groove into which the magnet 270 is inserted. A hook 2532 for supporting the magnet 270 may be provided in the protruding portion 253. The hook 2532 may be elastically deformed to prevent the magnet 270 from being separated when the magnet 270 is inserted into a groove 2530 of the protruding portion 253.

The protruding portion 253 may include slits 2531 provided to allow a portion of the magnet 270 to be exposed toward the second sensor 132. The slits 2531 may be provided on both sides of the hook 2532. The slit 2531 may have an open top. However, the number and shape of slits 2531 are not limited thereto and may vary.

Through the slits 2531 formed in the protruding portion 253, the exposed area of the magnet 270 may be increased. An increase in the exposed area of the magnet 270 may result in an increase in the area of a portion of the magnet 270 that is exposed to the second sensor 132 when the pre-filter 250 is mounted on the filter assembly 200. Accordingly, the sensitivity of the second sensor 132 may be improved.

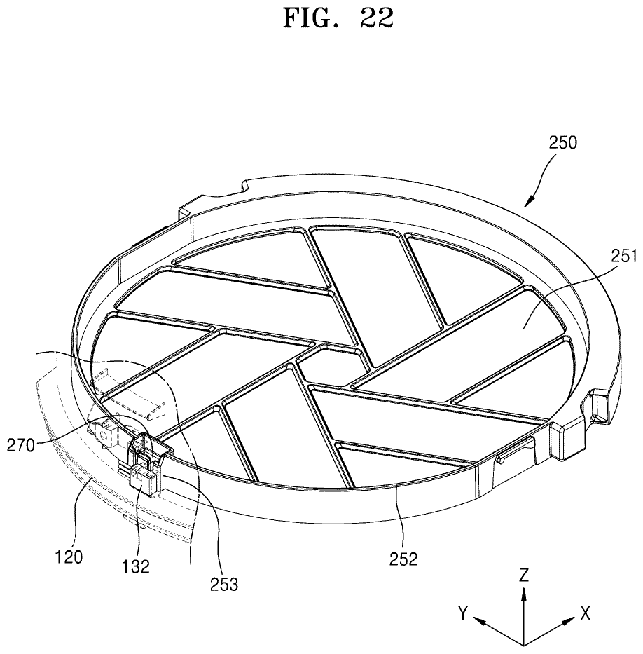

FIG. 22 is a perspective view illustrating an arrangement relationship between a detection module and a magnet in an air purifier according to an embodiment of the disclosure.

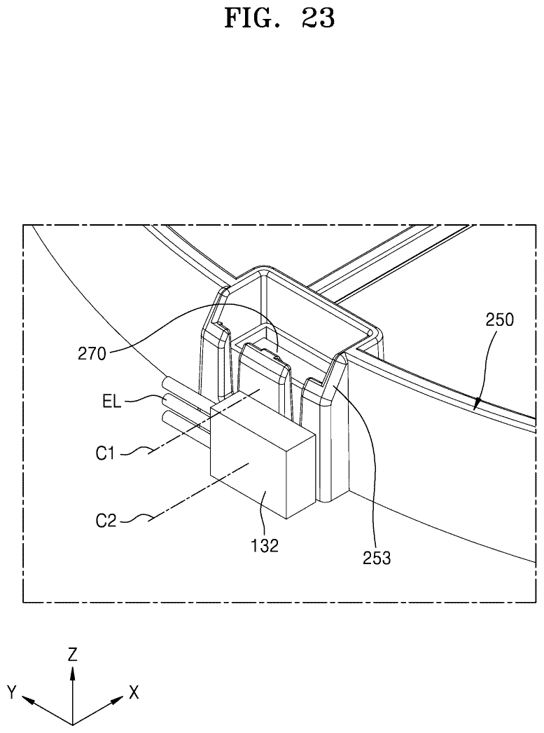

FIG. 23 is an enlarged view of a portion of FIG. 22 according to an embodiment of the disclosure.

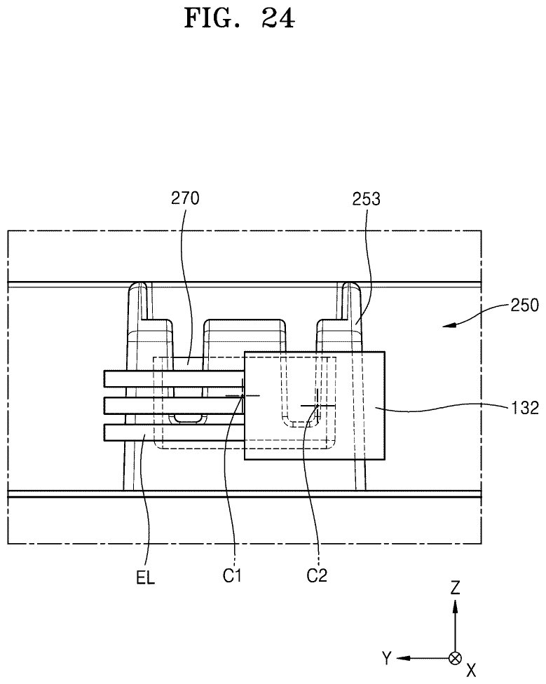

FIG. 24 is a front view of FIG. 23 according to an embodiment of the disclosure.

In FIGS. 23 and 24, for convenience of description, the inner frame 120 supporting the detection module 130 is omitted.

Referring to FIGS. 22, 23, and 24, the second sensor 132 may be arranged in the inner frame 120 such that a center C2 of the second sensor 132 deviates from a center C1 in the circumferential direction of the magnet 270. For example, the separation distance between the center C2 of the second sensor 132 and the center C1 of the magnet 270 in the circumferential direction may be less than the length of the magnet 270 in the circumferential direction. For example, one side of the second sensor 132 to which an electric wire EL is connected may be arranged to correspond to the center C2 in the circumferential direction of the magnet 270.

Through this arrangement of the second sensor 132, the sensitivity of the second sensor 132 may be further improved.

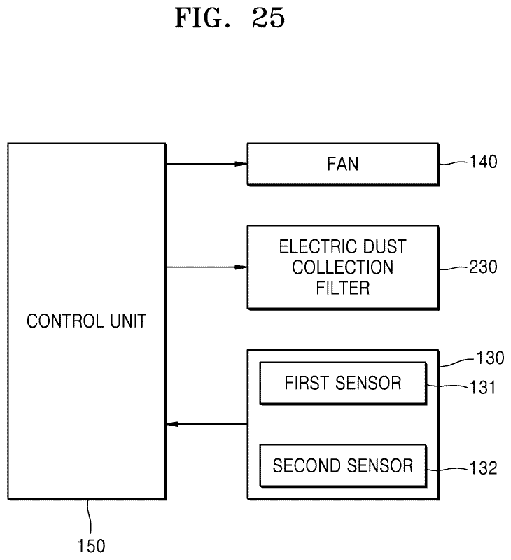

FIG. 25 is a block diagram schematically illustrating a control unit and related components of an air purifier according to an embodiment of the disclosure.

Referring to FIG. 25, the control unit 150 may control the operation of the air purifier 10 based on a result of detection by the detection module 130. For example, the control unit 150 may control the operation of the fan 140, the electric dust collection filter 230, and the like.

For example, the control unit 150 may control the air purifier 10 to operate only when both the dust collection filter 210 and the pre-filter 250 are mounted, based on results of detection by the first sensor 131 and the second sensor 132. For example, when the first sensor 131 detects that the dust collection filter 210 is not mounted, the control unit 150 may not operate the air purifier 10. For example, when the second sensor 132 detects that the pre-filter 250 is not mounted, the control unit 150 may not operate the air purifier 10. In other words, when any one of the dust collection filter 210 and the pre-filter 250 is not mounted, the control unit 150 may not operate the air purifier 10.

In a case in which the detection module 130 does not include the second sensor 132, the performance of the air purifier 10 may deteriorate or a user injury may occur. For example, in a case in which the detection module 130 includes the first sensor 131 and does not include the second sensor 132, the air purifier 10 may operate in a state in which the pre-filter 250 is not mounted on the filter assembly 200. When the air purifier 10 operates without the pre-filter 250, large foreign substances are not removed and are transferred to the dust collection filter 210, which may shorten the cleaning cycle or replacement cycle of the dust collection filter 210. In addition, when the user opens the door while the air purifier 10 is operating without the pre-filter 250, the charging unit 231 that needs to be covered by the pre-filter 250 may be exposed to the outside. In this case, there is a risk of electric shock when the user touches the charging unit 231.

In contrast, in the air purifier 10 according to an embodiment of the disclosure, the detection module 130 includes the second sensor 132 and the first sensor 131, and the control unit 150 controls the operation of the air purifier 10 based on a result of detection by the detection module 130, enabling prevention of a decrease in the cleaning cycle or replacement cycle of the dust collection filter 210, and prevention of an electric shock accident to the user.

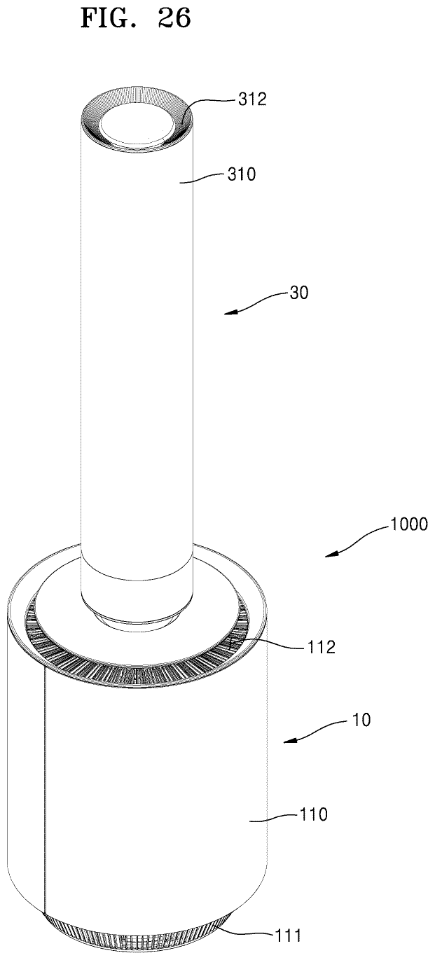

FIG. 26 is a perspective view illustrating an air purifying apparatus according to an embodiment of the disclosure.

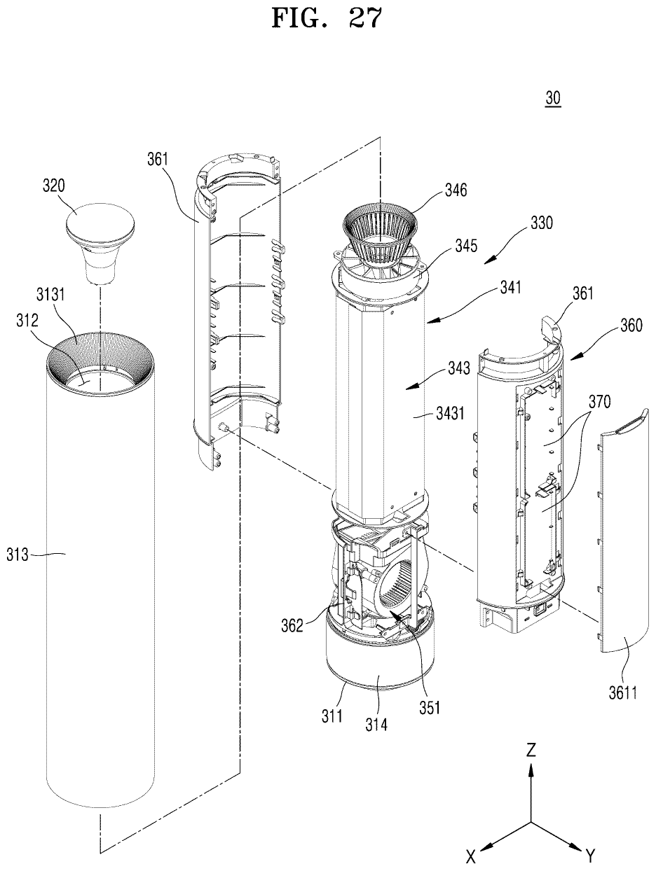

FIG. 27 is an exploded perspective view illustrating an air sterilizer of FIG. 26 according to an embodiment of the disclosure.

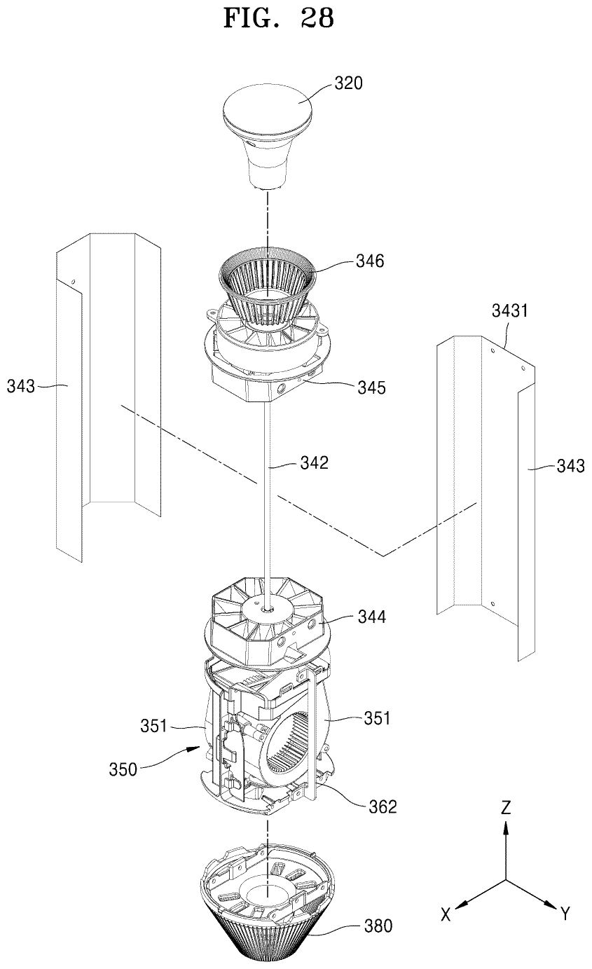

FIG. 28 is an exploded perspective view of a portion of an air sterilizer of FIG. 27 according to an embodiment of the disclosure.

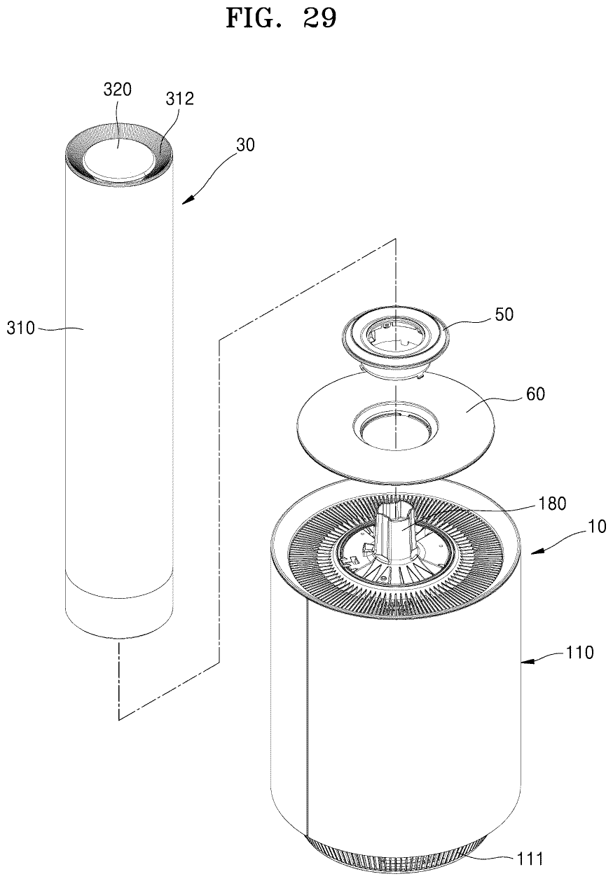

FIG. 29 is an exploded perspective view of a connection part of an air purifying apparatus of FIG. 26 according to an embodiment of the disclosure.

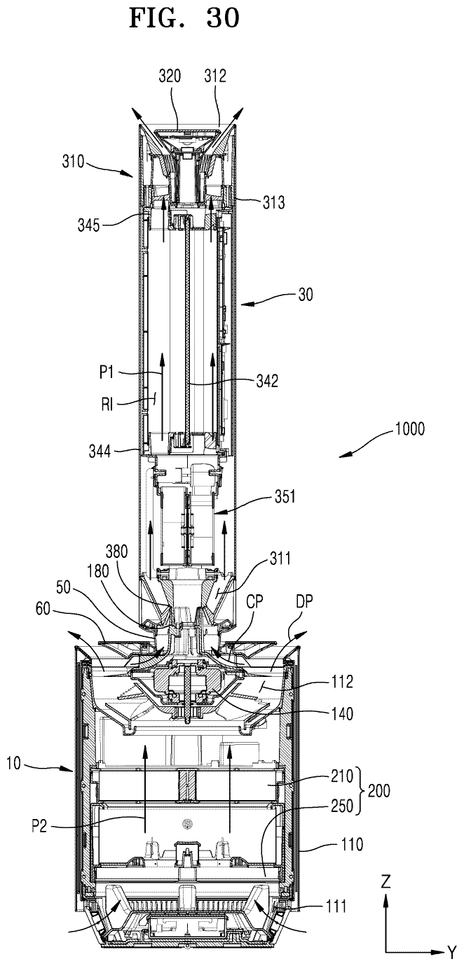

FIG. 30 is a cross-sectional view of an air purifying apparatus FIG. 26 according to an embodiment of the disclosure.

Referring to FIGS. 26, 27, 28, 29, and 30, the air purifying apparatus 1000 may be an apparatus designed to control air properties, such as temperature, humidity, cleanliness, or air flow. For example, the air purifying apparatus 1000 may be an apparatus for increasing the cleanliness of indoor air.

The air purifying apparatus 1000 according to an embodiment may include an air sterilizer 30 and the air purifier 10 according to the embodiment described above.

The air sterilizer 30 may be configured to sterilize air introduced from the outside, and discharge the sterilized air to the outside. For example, the air sterilizer 30 may include a second introduction port 311 and a second discharge port 312. The air sterilizer 30 may include a second flow path P2 provided between the second introduction port 311 and the second discharge port 312.

The air sterilizer 30 may include a housing 310 forming the exterior of the air sterilizer 30, and a main body module 330 arranged at least in part inside the housing 310. The main body module 330 may include an ultraviolet sterilization module 341 configured to generate ultraviolet rays, and a second fan 350 configured to form an air flow toward the ultraviolet sterilization module 341.

The ultraviolet sterilization module 341 may be arranged on the second flow path P2. The ultraviolet sterilization module 341 may include at least one ultraviolet light source 342 provided on the second flow path P2. The ultraviolet light source 342 generates ultraviolet rays, and a plurality of ultraviolet light sources 342 may be provided.

The ultraviolet light source 342 may be arranged inside the housing 310, and may sterilize air moving along the second flow path P2. The ultraviolet light source 342 may emit ultraviolet rays toward air introduced through the second introduction port 311. The ultraviolet light source 342 may generate ultraviolet-C (UVC) to remove bacteria contained in the air. The ultraviolet light source 342 may generate light with a wavelength of 220 nm to 280 nm. The ultraviolet light source 342 may remove contaminants, such as bacteria or viruses in the introduced air by emitting ultraviolet rays toward the introduced air.

The ultraviolet sterilization module 341 may include a reflective cover 343 designed to reflect ultraviolet rays emitted from the ultraviolet light source 342. The reflective cover 343 may cover an outer side of the ultraviolet light source 342. The reflective cover 343 may be provided in the second flow path P2.

At least a portion of the reflective cover 343 may include a metal material such that the inner surface of the reflective cover 343 facing the ultraviolet light source 342 reflects the ultraviolet rays. For example, the inner surface of the reflective cover 343 may include a material with high light reflectivity. For example, the inner surface of the reflective cover 343 may be plated with a metal, such as chrome. As another example, the entirety of the reflective cover 343, including its inner surface, may be configured as a plate made of a metal material with high light reflectivity.

The reflective cover 343 may have a curved shape. For example, the reflective cover 343 may include a plurality of flat plates, and the plurality of plate shapes may be arranged with certain angles therebetween to surround the ultraviolet light source 342.

The reflective cover 343 may have a polygonal cross-sectional structure. For example, the cross-sectional shape of the reflective cover 343 may be designed considering the arrangement of a second printed circuit board assembly 370 to be described below. For example, the cross-sectional shape of the reflective cover 343 may be an asymmetrical shape in which a plate 3431 facing the second printed circuit board assembly 370 is relatively larger than the other plates.

A plurality of reflective covers 343 may be provided. For example, the plurality of reflective covers 343 may each cover an outer side of the ultraviolet light source 342. For example, some of the plurality of reflective covers 343 may cover one side of the ultraviolet light source 342, and the other reflective covers 343 may cover the other side of the ultraviolet light source 342. However, the shape and number of reflective covers 343 are not limited thereto, and may be variously modified such that ultraviolet rays emitted from the ultraviolet light source 342 are reflected. For example, only one reflective cover 343 may be provided. For example, the reflective cover 343 may be manufactured by bending a single plate.

The air sterilizer 30 may include ultraviolet ray blocking members 344 and 345 provided to prevent ultraviolet rays emitted from the ultraviolet light source 342 from being incident on areas outside an irradiation area RI.

The ultraviolet ray blocking members 344 and 345 may be provided in the second flow path P2. The ultraviolet ray blocking member 344 and 345 may be formed to allow air flowing along the second flow path P2 to pass therethrough. The ultraviolet ray blocking members 344 and 345 may be provided to prevent the ultraviolet rays emitted from the ultraviolet light source 342 from being emitted to the outside of the irradiation area RI while allowing air to flow along the second flow path P2.

Through the ultraviolet ray blocking members 344 and 345 topped with element member 346, the internal parts of the air purifier provided outside the ultraviolet sterilization module 341 may be prevented from being damaged by ultraviolet rays, and the ultraviolet rays may be prevented from being emitted to the outside of the air purifier through the second discharge port 312.

The second fan 350 is for generating a flow inside the air sterilizer 30 and may be provided in the second flow path P2. The second fan 350 may be configured to form an air flow such that air introduced into the air sterilizer is directed toward the ultraviolet sterilization module 341.

The ultraviolet sterilization module 341 and the second fan 350 may be arranged along the second flow path P2. For example, the ultraviolet sterilization module 341 and the second fan 350 may be arranged in a first direction Z. For example, the second fan 350 may be arranged below the ultraviolet sterilization module 341. The second fan 350 may be arranged between the second introduction port 311 and the ultraviolet sterilization module 341. When the second fan 350 is driven, air introduced through the second introduction port 311 may sequentially pass through the second fan 350 and the ultraviolet sterilization module 341 to be discharged through the second discharge port 312. However, the arrangement of the second fan 350 is not limited thereto, and the second fan 350 may be arranged on the ultraviolet sterilization module 341.

The second fan 350 may include a plurality of blowers 351. The plurality of blowers 351 may be centrifugal blowers. The plurality of blowers 351 may have shapes corresponding to each other. The plurality of blowers 351 may be arranged symmetrically around the central axis of the housing 310.

Each of the plurality of blowers 351 may be arranged to discharge air toward the ultraviolet sterilization module 341. The direction in which air is discharged from some of the plurality of blowers 351, which is inclined with respect to the first direction Z may be arranged to be opposite to the direction in which air is discharged from the other blowers 351, which is inclined with respect to the first direction Z.

However, the shape, arrangement, number, and the like of the blowers 351 of the second fan 350 are not limited thereto and may vary. For example, the blower 351 may be another type of blower 351, such as an axial-flow-type blower, or only one blower 351 may be provided.

The main body module 330 may further include an inner frame 360. The inner frame 360 may be arranged inside the housing 310. The inner frame 360 may be provided to support at least some of the parts of the air sterilizer 30.

For example, the inner frame 360 may include a first support frame 361 that supports the ultraviolet sterilization module 341. The first support frame 361 may support the second printed circuit board assembly 370 and a control panel 320. The first support frame 361 may include a board mounting cover 3611 that covers the second printed circuit board assembly 370.

The inner frame 360 may further include a second support frame 362 that supports the second fan 350. The second support frame 362 may be coupled to the first support frame 361. However, the configuration of the inner frame 360 is not limited thereto, and the first support frame 361 and the second support frame 362 may be configured as one body, or the first support frame 361 or the second support frame 362 may be omitted.

The housing 310 forms at least a portion of the exterior of the air sterilizer 30, and the ultraviolet sterilization module 341 and the second fan 350 may be arranged inside the housing 310. The housing 310 may include the second introduction port 311 through which air is introduced, and the second discharge port 312 through which air is discharged.

The housing 310 may have a hollow structure that provides a space for accommodating at least a portion of the main body module 330. The housing 310 may have a cylindrical structure. The ultraviolet sterilization module 341 and the second fan 350 may be arranged inside the housing 310.

The housing 310 may have a length extending in the first direction Z, for example, in the vertical direction. For example, the housing 310 may have a shape in which the length in the first direction Z is greater than the width in a second direction Y that is perpendicular to the first direction Z. For example, the length of the housing 310 in the first direction Z may be three to seven times the width of the housing 310 in the second direction Y.

The housing 310 may be separated into an upper case 313 and a lower case 314. The second discharge port 312 may be provided in the upper case 313, and the second introduction port 311 may be provided in the lower case 314. For example, the second discharge port 312 may be provided at an end of the upper case 313, for example, at the upper end, and the second introduction port 311 may be provided at an end of the lower case 314, for example, at the lower end. An upper cover 3131 in which the second discharge port 312 is provided may be arranged in an upper portion of the upper case 313.

The control panel 320 may be arranged at an end of the upper case 313 to overlap the second discharge port 312 in the first direction Z. The control panel 320 may be arranged at a certain distance from the second discharge port 312 such that air is discharged through the second discharge port 312. The control panel 320 may be supported on the inner frame 360 by the inner frame 360.

A second coupling unit 380 for supporting the second fan 350 may be arranged inside the lower case 314. The second fan 350 and the second support frame 362 may be arranged on the second coupling unit 380. The second coupling unit 380 may be configured to be coupled to the air purifier.

The air purifier 10 may be assembled to be connected to the air sterilizer 30. The air purifier 10 may be detachably assembled to the air sterilizer 30. For example, the air purifier 10 may include a first coupling unit 180 provided to be coupled to the air sterilizer 30. For example, the first coupling unit 180 may be coupled to the second coupling unit 380 provided in a lower portion of the air sterilizer 30, such that the air purifier and the air sterilizer 30 may be connected to each other.

The air purifying apparatus 1000 may include an intermediate duct 50. The intermediate duct 50 may be provided between the housing 110 of the air purifier 10 and the housing 310 of the air sterilizer 30. The intermediate duct 50 may connect the housing 110 of the air purifier 10 to the housing 310 of the air sterilizer 30.

The intermediate duct 50 may be in communication with each of the discharge port 112 and the second introduction port 311. The intermediate duct 50 may be provided such that at least a portion of air discharged from the discharge port 112 flows into the second introduction port 311. The air sterilizer 30 may have the second introduction port 311 connected to the air purifier 10, and accordingly, air from which dust has been removed by the air purifier 10 may be sterilized by the ultraviolet sterilization module 341 of the air sterilizer 30.

A connection flow path CP may be provided between the second discharge port 312 of the air sterilizer 30 and the second introduction port 311 of the air purifier. A discharge flow path guide 60 may guide at least a portion of air discharged through the discharge port 112, excluding the air that flows into the second flow path P2 through the connection flow path CP, to flow along a discharge flow path DP when the fan 140 of the air purifier 10 and the second fan 350 of the air sterilizer 30 are driven simultaneously. For example, the discharge flow path guide 60 may cover at least a portion of the discharge port 112 from the outside.

In the air purifying apparatus 1000 according to the above-described embodiment of the disclosure, at least a portion of the air from which foreign substances have been removed by the air purifier 10 may be transferred to the air sterilizer 30. The air transferred to the air sterilizer 30 is sterilized by the ultraviolet light source 342 of the ultraviolet sterilization module 341 and then discharged to the outside through the second discharge port 312.

According to an embodiment of the disclosure, the detection module 130 and the control unit 150 allows the air purifier 10 to operate in a state in which both the dust collection filter 210 and the pre-filter 250 are mounted, and thus, air from which most foreign substances have been removed may be transferred to the air sterilizer 30.

In a case in which the sensor module 130 does not include the first and second sensors 131 and 132, the air purifying apparatus 1000 may operate in a state in which at least one of the dust collection filter 210 and the pre-filter 250 is not mounted. In this case, foreign substances may be contained in the air transferred to the air sterilizer 30, and the foreign substances may reduce the lifespan of the ultraviolet sterilization module 341. For example, foreign substances may adhere to the surroundings of the semi-permanent ultraviolet light source 342, which may cause a deterioration in the performance of the ultraviolet light source 342. In this case, it may lead to malfunction or reduced lifespan of the air sterilizer 30.

In contrast, because the air purifying apparatus 1000 according to an embodiment of the disclosure operates in a state in which both the dust collection filter 210 and the pre-filter 250 are mounted, foreign substances in the air introduced into the air sterilizer 30 may be minimized, and accordingly, the lifespan of the ultraviolet sterilization module 341 may be secured.

The embodiments of FIGS. 26, 27, 28, 29, and 30 are described above with an example in which the air purifier 10 is used as a component of the air purifying apparatus 1000, but the use of the air purifier 10 according to an embodiment is not limited thereto. For example, the air purifier 10 may be used as a component of a device other than the air purifying apparatus 1000, or may be used independently as a separate device from other devices.

For the purposes of promoting understanding of the disclosure, reference numerals are used in the preferred embodiments illustrated in the drawings, and particular terms are used to describe the embodiments of the disclosure, however, the disclosure is not limited by the terms and should be construed to encompass all components that would normally occur to those skilled in the art.

Particular executions described herein are merely examples and do not limit the scope of the disclosure in any way. For the sake of brevity, related-art electronics, control systems, software and other functional aspects of the systems may not be described further. Furthermore, line connections or connection members between elements depicted in the drawings represent functional connections and/or physical or circuit connections by way of example, and in actual applications, they may be replaced or embodied with various suitable additional functional connections, physical connections, or circuit connections. In addition, no item or component is essential to the practice of the disclosure unless the item or component is specifically described as being “essential” or “critical”. As used herein, the term, such as “comprising”, “including” and the like are used to be understood as being an open-ended term for description.

The term ‘the’ and other demonstratives similar thereto in the specification of the disclosure (especially in the following claims) should be understood to include a singular form and plural forms. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the operations of the methods described herein may be performed in any suitable order unless otherwise indicated herein or otherwise clearly contradicted by context. The disclosure is not limited to the described order of the operations. The use of any and all examples, or language (e.g., ‘and the like’) provided herein, is intended merely to better illuminate the disclosure and does not pose a limitation on the scope of the disclosure unless otherwise claimed. Furthermore, various changes and modifications will be readily apparent to one of ordinary skill in the art without departing from the spirit and scope of the disclosure.

According to an embodiment of the disclosure, an air purifier and an air purifying apparatus may prevent an operation in a state in which some filters are not mounted in a filter assembly configured to be equipped with a dust collection filter and a pre-filter together, through first and second sensors configured to detect whether the dust collection filter and the pre-filter are mounted, respectively.

According to an embodiment of the disclosure, the air purifier and the air purifying apparatus may prevent detection errors by improving the detection sensitivity for the pre-filter configured to be mounted on an inner frame through a dust collection filter.

An air purifier according to an embodiment of the disclosure may include a housing, an inner frame arranged inside the housing, a filter assembly configured to remove foreign substances from air introduced into the housing, and to be detachably mounted on the inner frame, and a detection module configured to detect whether the filter assembly is mounted.

The filter assembly may include a dust collection filter detachably mounted on the inner frame in a mounting direction, and a pre-filter that is detachably mounted on the dust collection filter in a direction parallel to the mounting direction, and is arranged on a flow path that leads to the dust collection filter.

The detection module may include a first sensor provided in the inner frame to detect whether the dust collection filter is mounted, and a second sensor provided in the inner frame to detect whether the pre-filter is mounted.

The pre-filter may include a filter area for removing the foreign substances from the air, and a frame area surrounding the filter area, and the frame area may include a protruding portion that protrudes in a radial direction toward the second sensor, and has a magnet arranged therein.

The dust collection filter may include a filter case detachably mounted on the inner frame, and an electric dust collection filter provided in the filter case.

The filter case may include an opening into which the protruding portion is inserted such that the protruding portion is exposed toward the second sensor.

The protruding portion may include a slit provided such that a portion of the magnet is exposed toward the second sensor.

The second sensor may be arranged in the inner frame such that a center of the second sensor deviates from a center in a circumferential direction of the magnet.

One side surface of the inner frame may be open to allow mounting and detachment of the filter assembly, and the inner frame may provide a seating surface for mounting the filter assembly, and the filter assembly and the inner frame may have a hook-coupling structure configured to maintain a mounting position of the filter assembly with respect to the inner frame.

The dust collection filter may further include a guide unit that guides a movement of the pre-filter when the pre-filter is mounted or detached, the pre-filter may further include a guide protrusion to be inserted into the guide unit, and a stopper that restricts movement of the guide protrusion such that the pre-filter maintains a mounting position with respect to the dust collection filter may be provided in the guide unit.

The electric dust collection filter may include a charging unit provided to charge foreign substances in the air that has passed through the pre-filter, and a dust collection unit provided to collect the charged foreign substances, and the dust collection unit may be mountable on and detachable from the filter case in a direction perpendicular to a mounting direction of the filter assembly.

The air purifier may further include a control unit configured to control an operation of the air purifier based on a result of detection by the detection module, and the control unit may be further configured to operate the air purifier in a state in which both the dust collection filter and the pre-filter are mounted, based on results of detection by the first sensor and the second sensor.

The pre-filter may be configured to filter out foreign substances of a first size, and the dust collection filter may be configured to filter out foreign substances of a second size that is less than the first size.

An air purifying apparatus according to an embodiment may include an air purifier configured to remove dust in air, and an air sterilizer configured to sterilize the air from which the dust has been removed.

The air purifier according to an embodiment may include a housing, an inner frame arranged inside the housing, a filter assembly configured to remove foreign substances from the air introduced into the housing, and to be detachably mounted on the inner frame, and a detection module configured to detect whether the filter assembly is mounted.

The filter assembly may include a dust collection filter detachably mounted on the inner frame in a mounting direction, and a pre-filter that is detachably mounted on the dust collection filter in a direction parallel to the mounting direction, and is arranged on a flow path that leads to the dust collection filter.

The detection module may include a first sensor provided in the inner frame to detect whether the dust collection filter is mounted, and a second sensor provided in the inner frame to detect whether the pre-filter is mounted.

The pre-filter may include a filter area for removing the foreign substances from the air, and a frame area surrounding the filter area, and the frame area may include a protruding portion that protrudes in a radial direction toward the second sensor, and has a magnet arranged therein.

The dust collection filter may include a filter case detachably mounted on the inner frame, and an electric dust collection filter provided in the filter case.

The filter case may include an opening into which the protruding portion filter is inserted such that the protruding portion is exposed toward the second sensor.

According to an embodiment of the disclosure, the air purifier and the air purifying apparatus may prevent an operation in a state in which some filters are not mounted in a filter assembly configured to be equipped with a dust collection filter and a pre-filter together.

According to an embodiment of the disclosure, the air purifier and the air purifying apparatus may prevent detection errors through a structure that improves the detection sensitivity of the pre-filter.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An air purifier comprising:
a housing;
an inner frame arranged inside the housing;
a filter assembly configured to remove foreign substances from air introduced into the housing, and to be detachably mounted on the inner frame; and
a detection module configured to detect whether the filter assembly is mounted,
wherein the filter assembly comprises:
a dust collection filter detachably mounted on the inner frame in a mounting direction (AX), and
a pre-filter detachably mounted on the dust collection filter in a direction parallel to the mounting direction, and is arranged on a flow path that is toward the dust collection filter, and
wherein the detection module comprises:
a first sensor provided in the inner frame to detect whether the dust collection filter is mounted, and
a second sensor provided in the inner frame to detect whether the pre-filter is mounted.

2. The air purifier of claim 1,
wherein the pre-filter comprises:
a filter area for removing the foreign substances from the air, and
a frame area surrounding the filter area, and
wherein the frame area comprises a protruding portion that protrudes in a radial direction toward the second sensor, and has a magnet arranged therein.

3. The air purifier of claim 2, wherein the dust collection filter comprises:
a filter case detachably mounted on the inner frame; and
an electric dust collection filter provided in the filter case.

4. The air purifier of claim 3, wherein the filter case comprises an opening into which the protruding portion is inserted such that the protruding portion is exposed toward the second sensor.

5. The air purifier of claim 4, wherein the protruding portion comprises a slit provided such that a portion of the magnet is exposed toward the second sensor.

6. The air purifier of claim 2, wherein the second sensor is arranged in the inner frame such that a center (C2) of the second sensor deviates from a center (C1) in a circumferential direction of the magnet.

7. The air purifier of claim 1,
wherein one side surface of the inner frame is open to allow mounting and detachment of the filter assembly,
wherein the inner frame provides a seating surface for mounting the filter assembly, and
wherein the filter assembly and the inner frame have a hook-coupling structure configured to maintain a mounting position of the filter assembly with respect to the inner frame.

8. The air purifier of claim 1,
wherein the dust collection filter further comprises a guide unit that guides a movement of the pre-filter when the pre-filter is mounted or detached,
wherein the pre-filter further comprises a guide protrusion to be inserted into the guide unit, and
wherein a stopper that restricts movement of the guide protrusion such that the pre-filter maintains a mounting position with respect to the dust collection filter is provided in the guide unit.

9. The air purifier of claim 3,
wherein the electric dust collection filter comprises a charging unit provided to charge foreign substances in the air that has passed through the pre-filter, and a dust collection unit provided to collect the charged foreign substances, and
wherein the dust collection unit is mountable on and detachable from the filter case in a direction perpendicular to a mounting direction of the filter assembly.

10. The air purifier of claim 1, further comprising:
a control unit configured to control an operation of the air purifier based on a result of detection by the detection module,
wherein the control unit is further configured to operate the air purifier in a state in which both the dust collection filter and the pre-filter are mounted, based on results of detection by the first sensor and the second sensor.

11. The air purifier of claim 1,
wherein the pre-filter is configured to filter out foreign substances of a first size, and
wherein the dust collection filter is configured to filter out foreign substances of a second size that is less than the first size.

12. An air purifying apparatus comprising:
an air purifier configured to remove dust from air; and
an air sterilizer configured to sterilize the air from which dust has been removed,
wherein the air purifier comprises:
a housing,
an inner frame arranged inside the housing,
a filter assembly configured to remove foreign substances from the air introduced into the housing, and to be detachably mounted on the inner frame, and
a detection module configured to detect whether the filter assembly is mounted,
wherein the filter assembly comprises:
a dust collection filter detachably mounted on the inner frame in a mounting direction, and
a pre-filter detachably mounted on the dust collection filter in a direction parallel to the mounting direction, and is arranged on a flow path that leads to the dust collection filter, and
wherein the detection module comprises:
a first sensor provided in the inner frame to detect whether the dust collection filter is mounted, and
a second sensor provided in the inner frame to detect whether the pre-filter is mounted.

13. The air purifying apparatus of claim 12,
wherein the pre-filter comprises:
a filter area for removing the foreign substances from the air, and
a frame area surrounding the filter area, and
wherein the frame area comprises a protruding portion that protrudes in a radial direction toward the second sensor, and has a magnet arranged therein.

14. The air purifying apparatus of claim 13, wherein the dust collection filter comprises:
a filter case detachably mounted on the inner frame, and
an electric dust collection filter provided in the filter case.

15. The air purifying apparatus of claim 14, wherein the filter case comprises an opening into which the protruding portion is inserted such that the protruding portion is exposed toward the second sensor.

16. The air purifying apparatus of claim 15, wherein the protruding portion comprises a slit provided such that a portion of the magnet is exposed toward the second sensor.

17. The air purifying apparatus of claim 13, wherein the second sensor is arranged in the inner frame such that a center (C2) of the second sensor deviates from a center (C1) in a circumferential direction of the magnet.

18. The air purifying apparatus of claim 12,
wherein one side surface of the inner frame is open to allow mounting and detachment of the filter assembly,
wherein the inner frame provides a seating surface for mounting the filter assembly, and
wherein the filter assembly and the inner frame have a hook-coupling structure configured to maintain a mounting position of the filter assembly with respect to the inner frame.

19. The air purifying apparatus of claim 12,
wherein the dust collection filter further comprises a guide unit that guides a movement of the pre-filter when the pre-filter is mounted or detached,
wherein the pre-filter further comprises a guide protrusion to be inserted into the guide unit, and
wherein a stopper that restricts movement of the guide protrusion such that the pre-filter maintains a mounting position with respect to the dust collection filter is provided in the guide unit.

20. The air purifying apparatus of claim 14,
wherein the electric dust collection filter comprises a charging unit provided to charge foreign substances in the air that has passed through the pre-filter, and a dust collection unit provided to collect the charged foreign substances, and
wherein the dust collection unit is mountable on and detachable from the filter case in a direction perpendicular to a mounting direction of the filter assembly.
